(19) United States
(12) Patent Application Publication
(10) Pub. No.: US 2024/0360721 A1
(43) Pub. Date: Oct. 31, 2024

(54) EXTERNAL MOTOR DRIVE SYSTEM FOR CONTROLLING MOVEMENT OF WINDOW COVERINGS WITH CONTINUOUS CORD LOOP

(71) Applicant: Ryse Inc., Toronto (CA)

(72) Inventors: Trung PHAM, Toronto (CA); Nabeel AHMED, Toronto (CA)

(73) Assignee: Ryse Inc., Toronto, ON (CA)

(21) Appl. No.: 18/291,892

(22) PCT Filed: Aug. 16, 2022
(86) PCT No.: PCT/CA2022/051244

§ 371 Date: Jan. 24, 2024

Related U.S. Application Data
(60) Provisional application No. 63/235,619, filed on Aug. 20, 2021.

(51) Int. Cl. E06B 9/322; E06B 9/68; G05B 19/042

(52) U.S. Cl. CPC E06B 9/322; G05B 19/042; E06B 2009/6845; E06B 2009/6863

(57) ABSTRACT

A drive system for raising and lowering a window covering using a continuous cord loop that includes a motor with an associated encoder, device controller for the motor, a speed sensor, and proportional-integral-derivative (PID) layer. The device controller stores or receives a desired motor speed and generates a speed command signal to the motor. A closed-loop system applies a PID speed control algorithm to an error representing a difference between actual motor speed and desired motor speed. The PID layer uses the error to calculate a new output via PID control terms to automatically correct signals to the motor to achieve desired motor speed. A hembar alignment function automates positional control of a plurality of motor drive systems to synchronize raising or lowering of window covering shades with the shades in positional alignment. A system controller includes a time-counter indexed to a position scale to synchronize hembar alignment positional commands.

### CROSS-REFERENCE TO RELATED APPLICATION

This application is a U.S. National Phase Application under 35 U.S.C. 371 of International Application No. PCT/CA2022/051244, filed Aug. 16, 2022, which claims the benefit of and priority to U.S. Provisional App. No. 63/235,619, filed Aug. 20, 2021, titled “External Motor Drive System Adjusting for Creep in Window Covering System with Continuous Cord Loop,” each of which is incorporated by reference in its entirety.

### TECHNICAL FIELD

The present disclosure relates to a system for raising and lowering window coverings that use continuous cord loops and, more particularly, to an external motor drive device for a system for raising and lowering window coverings.

### BACKGROUND

Window covering systems for raising and lowering window coverings for architectural openings such as windows, archways, and the like are commonplace. Such systems can include various control mechanisms, such as pull cords that hang from one or both ends of the headrail. The pull cord may hang linearly, or, in the type of window covering systems addressed by the present invention, the pull cord may assume the form of a closed loop of flexible material such as a rope, cord, or beaded chain, herein referred to as a continuous cord loop, or alternatively as a chain/cord.

### SUMMARY

Automated control of window covering motor drive systems can provide useful control functions. Examples of such automated control functions include controlling multiple blinds in a coordinated, centralized fashion. There is a need for centralized position control of multiple window blinds to control motion in coordinated, visually attractive alignment.

The embodiments described herein include a motor drive system for operating a mechanism including a continuous cord loop for raising and lowering window coverings. The motor drive system may advance the continuous cord loop in response to one or both position commands and speed commands from a controller. There is a need to maintain accuracy of automated control of window covering functions while compensating for physical effects of a continuous cord loop motor drive system. There is a need to ensure that actual speed of a motor drive system achieves a desired speed. There is a need for centralized position control of multiple blinds to control motion in coordinated, visually attractive alignment. In this regard, there is a need to compensate for environmental factors that can affect speed.

Drive systems of the present disclosure incorporate a motor and controlling electronics mounted externally to a mechanism including a continuous cord loop for raising and lowering a window covering. Such drive system is herein called an “external motor,” “external motor device,” “external motor drive,” or “external motor system,” and alternatively is sometimes called an “external actuator.” External motor devices are typically mounted externally on the window frame or wall, and engage the cords or chains (continuous cord loop) of window coverings in order to automate opening and closing the window coverings.

In an embodiment, a motor drive system comprises a motor configured to operate under electrical power to rotate an output shaft of the motor, wherein the motor is external to a mechanism for raising and lowering a window covering. The motor drive system includes a drive assembly configured for engaging and advancing a continuous cord loop coupled to the mechanism for raising and lowering the window covering. Advancing the continuous cord loop in a first direction raises the window covering, and advancing the continuous cord loop in a second direction lowers the window covering. The motor drive system includes a controller for providing positional commands to the motor to control advancing the continuous cord loop in the first direction and advancing the continuous cord loop in the second direction. An I/O device for the controller includes an input interface that receives user inputs via “up” and “down” buttons or touch inputs along an input axis to cause the controller to provide the positional commands to the motor.

In an embodiment, a drive system for raising and lowering a window covering using a continuous cord loop includes a motor with associated encoder, a device controller for the motor, a speed sensor, and a proportional-integral-derivative (PID) layer. The device controller stores or receives a desired motor speed and generates a speed command signal to the motor. A closed-loop system applies a PID speed control algorithm to an error representing a difference between actual motor speed and desired motor speed. The PID layer uses the error to calculate a new output via PID control terms to automatically correct signals to the motor to achieve desired motor speed.

In an embodiment, the motor is a DC motor with an encoder. A control component of the speed sensor receives and analyzes encoder output pulses based upon rotation of the output shaft of the motor to generate an actual speed of rotation signal representing sensed speed of rotation of the DC motor. In an embodiment, the control component of the speed sensor includes a quadrature decoder state machine that determines position increment or decrement steps of positional commands to the motor based upon first encoder output pulses and second encoder output pulses received by the control device.

A hembar alignment function automates positional control of a plurality of external motor devices to synchronize raising or lowering of window covering shades with the shades in positional alignment. A system controller may include a time-counter indexed to a position scale to synchronize positional commands. A system controller calculates positional commands to the devices to control advancing of continuous cord loops to cause positional alignment of two or more of the window covering shades over at least part of the shades' movement. In an embodiment, the positional alignment appears to the user as synchronized movement of the shades at the same speed, with lower edges of the shades aligned at the same level of openness.

Each of motor drive devices may include a device controller operatively coupled to a respective motor. The system controller may include a bridge that transmits and receives wireless signals to and from the device controllers. In an embodiment, the system controller includes a time-counter indexed to a position scale to synchronize positional commands. The system controller may store calibrated position settings representing a fully open position and a fully closed position of each of the motor control devices. The stored position settings may be used to calculate respective position values of each motor control device.

In various embodiments, the window covering mechanism including a continuous cord loop is advanced by a driven wheel that is coupled to the motor. In various embodiments, the continuous cord loop comprises a chain-type continuous cord loop, also herein called a continuous cord loop chain, and the driven wheel comprises a sprocket wheel. Embodiments described herein incorporate a continuous cord loop sensor system to maintain accuracy of automated positioning control of window coverings in the event of physical effects of the continuous cord loop chain such as stretching.

In various embodiments, a drive system is configured for use with a window covering system including a mechanism for extending and retracting a window covering and a continuous cord loop extending below the mechanism. The continuous cord loop comprises an endless loop of flexible material and one or more sensor targets disposed on the endless loop of flexible material. The present disclosure alternatively refers to a sensor target as a marker or a target.

Additional components of the drive system include a controller for the motor, a sensor operatively connected to the controller, and a housing for the motor, the driven wheel, and the controller. The housing includes a guide rail adjacent to the driven wheel, wherein the sensor is mounted to the guide rail and is configured to generate a signal indicating presence of the sensor target (or one of multiple sensor targets) when the sensor target is located in proximity to or in contact with the sensor. In an embodiment, the controller is calibrated to store an initial position of a single sensor target along the continuous cord loop. In an embodiment, the controller is calibrated to store initial positions of a plurality of sensor targets at different positions along the continuous cord loop. The controller is configured to receive the signal indicating the presence of a sensor target and to identify a drift (e.g., shift or change in values) from the initial position or multiple initial positions during continuing operation of the drive system.

In an embodiment, a motor drive system comprises a first motor configured to operate under electrical power to rotate an output shaft of the first motor, wherein the first motor is external to a first mechanism for raising and lowering a first window covering; a first drive system coupled to the output shaft of the first motor for engaging and advancing a first continuous cord loop coupled to the first mechanism for raising and lowering the first window covering, wherein advancing the first continuous cord loop in a first direction raises the first window covering, and advancing the continuous cord loop in a second direction lowers the first window covering; a second motor configured to operate under electrical power to rotate an output shaft of the second motor, wherein the second motor is external to a second mechanism for raising and lowering a second window covering; a second drive system coupled to the output shaft of the second motor for engaging and advancing a second continuous cord loop coupled to the second mechanism for raising and lowering the second window covering, wherein advancing the second continuous cord loop in a second direction raises the second window covering, and advancing the continuous cord loop in a second direction lowers the second window covering; and a system controller for providing positional commands to the first motor and the second motor to control the advancing the first continuous cord loop and the second continuous cord loop, wherein in response to receiving an instruction to advance the first continuous cord loop and the second continuous cord loop in one of the first direction or the second direction, the system controller calculates the positional commands to the first motor and the second motor to control the advancing of the first continuous cord loop and the second continuous cord loop to cause positional alignment of the first window covering and the second window covering over at least part of the advancing.

In an embodiment, a drive system for use with a window covering system including a mechanism associated with raising and lowering a window covering and a continuous cord loop extending below the mechanism for raising and lowering the window covering, comprises a motor configured to rotate an output shaft of the motor; a drive assembly coupled to the output shaft of the motor and configured for engaging and advancing the continuous cord loop, wherein advancing the continuous cord loop in a first direction raises the window covering and advancing the continuous cord loop in a second direction lowers the window covering; a controller configured to transmit a speed command signal to control the speed of rotation of the output shaft of the motor for advancing the continuous cord loop; and a sensor for generating an actual speed of rotation signal representing a sensed speed of rotation of the output shaft of the motor, wherein the controller comprises a proportional-integral-derivative (PID) control layer that calculates an error representing a difference between the actual speed of rotation and a speed set-point signal representing a desired speed of rotation of the output shaft of the motor, and that applies PID control terms to the error to adjust the speed command signal to the motor.

In another embodiment, a motor drive system comprises a motor configured to operate under electrical power to rotate an output shaft of the motor, wherein the motor is external to a mechanism for raising and lowering a window covering; a drive assembly configured for engaging and advancing a continuous cord loop coupled to the mechanism for raising and lowering the window covering, wherein advancing the continuous cord loop in a first direction raises the window covering, and advancing the continuous cord loop in a second direction lowers the window covering; a controller for providing positional commands to the motor and the drive assembly to control the advancing the continuous cord loop in the first direction and the advancing the continuous cord loop in the second direction; wherein the drive assembly comprises an electrically powered coupling mechanism coupling the drive assembly to the output shaft of the motor and configured for rotating the driven wheel in first and second senses, and a motor controller for powering the electrically powered coupling mechanism; wherein the controller and motor controller are configured to execute a motor ramp trajectory speed control that limits acceleration of the motor from an idle state to full operating speed, and limits deceleration of the motor from full operating speed back to the idle state.

In an embodiment, a drive system for use with a window covering system including a headrail, a mechanism associated with the headrail for spreading and retracting a window covering, and a continuous cord loop extending below the headrail for actuating the mechanism for spreading and retracting the window covering comprises a motor configured to rotate an output shaft of the motor; a drive assembly configured for engaging and advancing the continuous cord loop coupled to the mechanism for spreading and retracting the window covering, wherein advancing the continuous cord loop in a first direction spreads the window covering, and advancing the continuous cord loop in a second direction retracts the window covering; a controller configured to provide positional commands to the motor and the drive assembly to control the advancing the continuous cord loop in the first direction and the advancing the continuous cord loop in the second direction; and an I/O device for the controller including a graphical user interface configured to receive user inputs to cause the controller to control the positional commands to the motor and the drive assembly at a selected speed of the advancing the continuous cord loop in a selected one of the first direction or the second direction, wherein in a first speed control mode the I/O device causes the controller to control the speed of the advancing the continuous cord loop at a selected percentage within a range of speeds from stationary to a maximum speed, and in a second speed control mode the input output device causes the controller to control the speed of the advancing the continuous cord loop at a selected one of a limited number of predetermined speed levels.

In an embodiment, a motor drive system comprises a motor configured to operate under electrical power to rotate an output shaft of the motor, wherein the motor is external to a mechanism for raising and lowering a window covering; a drive assembly configured for engaging and advancing a continuous cord loop coupled to the mechanism for raising and lowering the window covering, wherein advancing the continuous cord loop in a first direction raises the window covering, and advancing the continuous cord loop in a second direction lowers the window covering; a controller for providing positional commands to the motor and the drive assembly to control the advancing of the continuous cord loop in the first direction and the advancing of the continuous cord loop in the second direction to control the raising and lowering the window covering; and a set control module for user calibration of a top position and a bottom position of the window covering, wherein following the user calibration the controller limits the raising and lowering the window covering between the top position and the bottom position.

In one embodiment, a drive system for use with a window covering system, the window covering system including a mechanism for raising and lowering a window covering and a continuous cord loop extending below the mechanism; the drive system comprises a motor configured to operate under electrical power to rotate an output shaft of the motor; a driven wheel coupled to the output shaft of the motor and configured to engage the continuous cord loop, wherein rotation of the driven wheel in a first direction advances the continuous cord loop to cause the mechanism to raise the window covering and rotation of the driven wheel in second direction advances the continuous cord loop to cause the mechanism to lower the window covering; one or more sensor targets disposed on the continuous cord loop; a controller for the motor; and a sensor operatively connected to the controller and configured to generate a signal indicating presence of each of the one or more sensor targets disposed on the continuous cord loop when the sensor target is located in proximity to or in contact with the sensor.

In another embodiment, a drive system may be used with a window covering system, the window covering system including a roller blind mechanism for raising and lowering a window covering fabric and a continuous cord loop extending below the mechanism; the drive system comprises: a motor configured to operate under electrical power to rotate an output shaft of the motor; a driven wheel coupled to the output shaft of the motor and configured to engage the continuous cord loop; one or more sensor targets disposed on the continuous cord loop; a controller for the motor; and a sensor operatively connected to the controller and is configured to generate a signal indicating presence of the sensor target on the continuous cord loop when the sensor target is located in proximity to or in contact with the sensor, wherein the controller is calibrated to store a position of each of the one or more sensor targets along the continuous cord loop and is configured to receive the signal indicating presence of each sensor target and to identify a drift from the respective position during continuing operation of the drive system.

Additional features and advantages of an embodiment will be set forth in the description which follows and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure.

FIG. 1 is an isometric view of an external motor device, according to an embodiment.

FIG. 2 is an exploded view of disassembled components of an external motor device, according to an embodiment.

FIG. 3 is an isometric view of an external motor device with cover of a driven wheel compartment in an opened position, according to an embodiment.

FIG. 4 is an elevation view of an external motor device, with cover removed to show a sprocket driven wheel, according to an embodiment.

FIG. 5 is a perspective view of a window covering system with an external motor system installed on a flat wall, according to an embodiment.

FIG. 6 is a perspective view of an installed external motor system for a window covering system, according to an embodiment.

FIG. 7 is a block diagram of a control system architecture of an external motor device for a window covering system, according to an embodiment.

FIG. 8 is a schematic diagram of monitored and controlled variables of an external motor control system for a window covering system, according to an embodiment.

FIG. 9 is an elevation view of structural components and assembled motor drive components for an external motor system, according to an embodiment.

FIG. 10 is a block diagram of a control system for a plurality of external motor devices, according to an embodiment.

FIG. 11 shows a DC motor with associated encoder and drive assembly for raising and lowering a window covering, according to an embodiment.

FIGS. 12A and 12B show two signals generated by a motor encoder, according to an embodiment.

FIG. 13 is a diagram of a decoder state machine, according to an embodiment.

FIG. 14 shows architecture of a window covering motor drive system with a speed sensor and proportional-integral-derivative (PID) speed control layer, according to an embodiment.

FIG. 15 is a front view of a graphical user interface displayed on an electronic device that presents a speed control screen of an external motor control application, according to an embodiment.

FIGS. 16A-16F illustrate six stages of a hembar alignment process, according to an embodiment.

FIG. 17 is a front view of a graphical user interface displayed on an electronic device that presents a set-up screen an external motor control application, according to an embodiment.

FIG. 18 is an elevation view of upper portions of three different external motor devices with cover removed to show a driven wheel and continuous cord loop, according to an embodiment.

FIG. 19 is an elevation view of upper portion of an external motor device with cover removed to show a driven wheel and continuous cord loop, according to an embodiment.

FIG. 20 is an isometric view of a curved guide rail with mounting surface for infrared sensor, according to an embodiment.

FIG. 21 is an isometric view of an infrared sensor on printed circuit board, according to an embodiment.

FIG. 22 is an isometric view of a curved guide rail with a leaf spring contacts sensor, according to an embodiment.

FIG. 23 is a perspective view of a curved guide rail with a flat contacts sensor, according to an embodiment.

FIG. 24 is an isometric view of a flat guide rail with a flat contacts sensor, according to an embodiment.

FIG. 25 is a perspective view of a flat guide rail with a wire contacts sensor, according to an embodiment.

FIG. 26 is a flow chart diagram of a grouping mesh routine, according to an embodiment.

FIG. 27 is a flow chart diagram of a calibration routine for an external motor drive system, according to an embodiment.

FIG. 28 is a flow chart diagram of a shade control routine, according to an embodiment.

FIG. 29 is an isometric view of an external motor device, according to a further embodiment.

### DETAILED DESCRIPTION

The present disclosure is herein described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here. Furthermore, the various components and embodiments described herein may be combined to form additional embodiments not expressly described, without departing from the spirit or scope of the invention.

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of the invention.

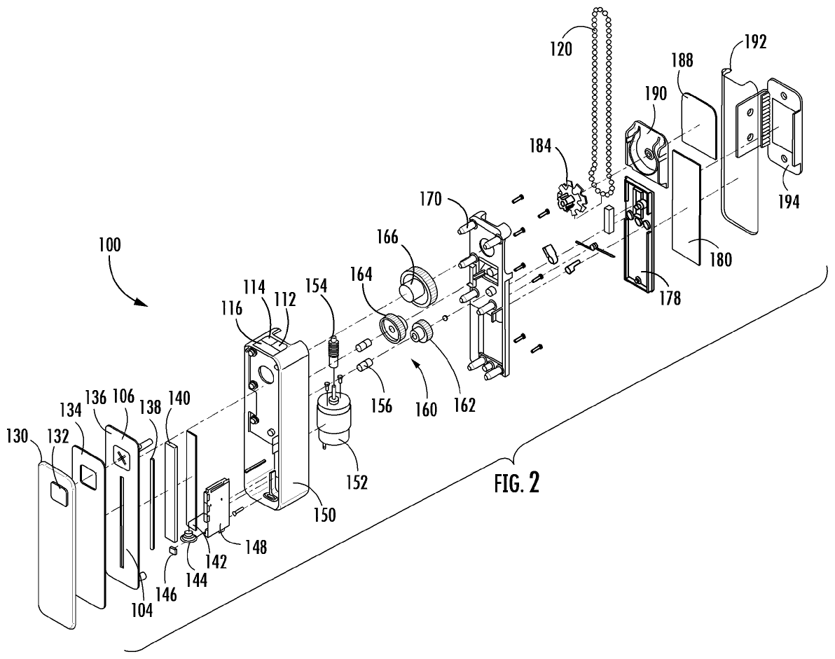

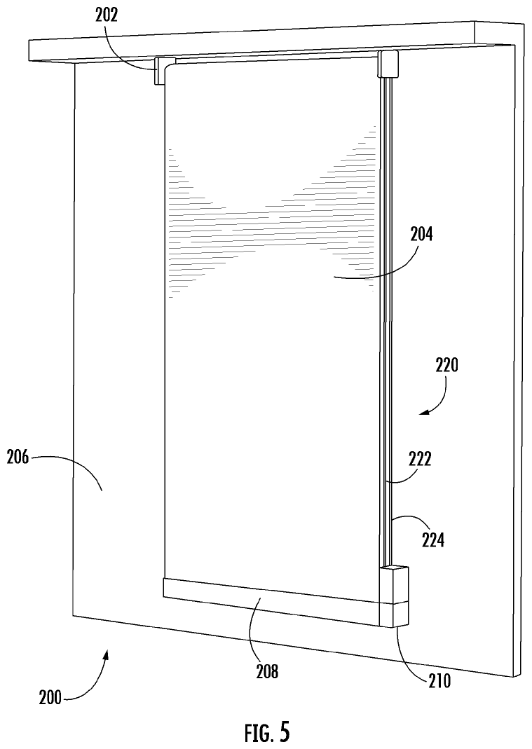

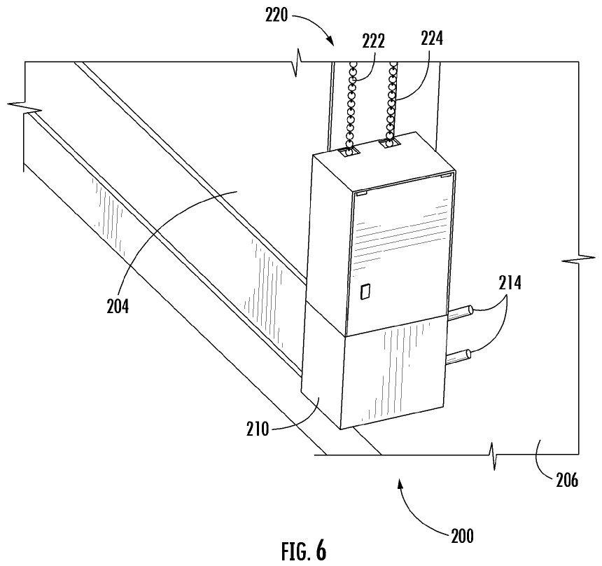

The present disclosure describes various embodiments of an external motor device for controlling the operation of a window covering system. The external motor device may employ on-device control, may employ a separate control device (e.g., a mobile computing device, a voice control device), or both. In some embodiments, the external motor device may be integrated with third-party platforms. As used in the present disclosure, a “window covering system” is a system for raising and lowering a window covering. In an embodiment as shown at 200 in FIG. 5, the window covering system includes a headrail 202, and a mechanism (not shown) associated with the headrail (i.e., a mechanism within the headrail or adjacent to the headrail) for raising and lowering a window covering. In this embodiment, the window covering system 200 includes a continuous cord loop 220 extending below the headrail for actuating the mechanism associated with the headrail to raise and lower the window covering. As used in the present disclosure, “headrail” is a broad term for a structure of a window covering system including a mechanism for raising and lowering the window covering. The window covering system further includes an external motor 210. Continuous cord loop 220 operatively couples the window covering mechanism associated with headrail 202 to the external motor 210 to raise and lower a window shade (fabric or blind) 204. As seen in FIG. 5, external motor 210 is mounted to the wall 206 adjacent to the window, which is covered by shade 204 in this view. For example, external actuator may be mounted to wall 206 using hardware such as bolts 214 in FIG. 6, or using a mounting fixture such as bracket 194 in FIG. 2. In an embodiment, the window shade 204 includes a hembar 208 at the bottom edge of a roller shade, such as a metal strip welded into a pocket made by folding over the shade fabric or similar structure.

In the present disclosure, “window covering” includes any covering material that may be raised and lowered to cover a window or other architectural opening using a continuous cord loop system (i.e., system with a mechanism for raising and lowering the window covering using a continuous cord loop). Such window coverings include most shades and blinds as well as other covering materials, such as roller shades; honeycomb shades; horizontal sheer shades, pleated shades, woven wood shades, Roman shades, Venetian blinds, Pirouette® shades (Pirouette is a trademark of Hunter Douglas N. V., Rotterdam, Germany), and certain systems for opening and closing curtains and drapery. Window covering embodiments described herein refer to blind or blinds, it being understood that these embodiments are illustrative of other forms of window coverings.

As used in the present disclosure, a “continuous cord loop” is an endless loop of flexible material, such as fiber cord, beaded chain, or ball chain. As used in the present disclosure, fiber cord continuous cord loops are sometimes referred to as cord-type continuous cord loops, continuous cord loop cords, or simply cords. Chain-type continuous cord loops are sometimes referred to herein as continuous cord loop chains. Various types of metal and plastic beaded chain and ball chain are commonly used as continuous cord loops for window covering systems. A typical ball chain diameter is 5 mm (0.2 inch), and may include metal and plastic beaded chains or ball chains. A cord-type continuous cord loop includes a length of natural or synthetic fiber. Continuous cord loops in the form of loops of fiber are available in various types and ranges of diameter including for example D-30 (˜2.7 mm diameter), C-30 (˜3.2 mm diameter, D-40 (˜3.2 mm diameter), and K-35 (˜3.4 mm diameter). In various embodiments, cords are made from lengths of fiber that are braided, twisted, or plaited together forming a round composite structure. Synthetic fiber cords may be formed, for example, of nylon, polypropylene, or polyester. Natural fiber cords may be formed of manila or sisal, for example.

The continuous cord loop includes two substantially parallel cords or chains having a total length (e.g., 1 m) and a loop length or “drop” (e.g., 0.5 m). Continuous cord loops come in different cord loop lengths, i.e., the length between the first loop end and the second loop end, sometimes rounded off to the nearest foot. In a common window covering system design, the continuous cord loop includes a first loop end at the headrail engaging a mechanism associated with the headrail for raising and lowering the window covering and includes a second loop end remote from the headrail. In one embodiment, e.g., in a roller blinds system, the continuous cord loop extends between the headrail and the second loop end, but does not extend across the headrail. In this embodiment, the first loop end may wrap around a clutch that is part of the mechanism raising and lowering the blind. In another embodiment, e.g., in a vertical blinds system, a segment of the continuous cord loop extends across the headrail. In an embodiment, the continuous cord loop extends below the headrail in a substantially vertical orientation. When retrofitting the present external motor device to control a previously installed window coverings system, the continuous cord loop may be part of the previously installed window coverings mechanism. Alternatively, the user can retrofit a continuous cord loop cord or chain to a previously installed window coverings mechanism.

Embodiments described herein generally refer to raising and lowering window coverings (e.g., blinds or shades) either under control of an external motor system or manually, it being understood that these embodiments are illustrative of other motions for raising and lowering window coverings. External actuator 210 incorporates a motor drive system and controlling electronics for automated movement of the continuous cord loop 220 in one of two directions to raise or lower the blind 204. In one embodiment of window covering system 200, the continuous cord loop 220 includes a rear cord/chain 224 and a front cord/chain 222. In this embodiment, pulling down the front cord raises the blind, and pulling down the rear cord lowers the blind. As used in the present disclosure, to “advance” the continuous cord loop means to move the continuous cord loop in either direction (e.g., to pull down a front cord of a continuous cord loop or to pull down a back cord of a continuous cord loop). In an embodiment, the blind automatically stops and locks in position when the continuous cord loop is released. In an embodiment, when at the bottom of the blind, the rear cord of the continuous cord loop can be used to open any vanes or slats in the blind, while the front cord can be used to close these vanes or slats.

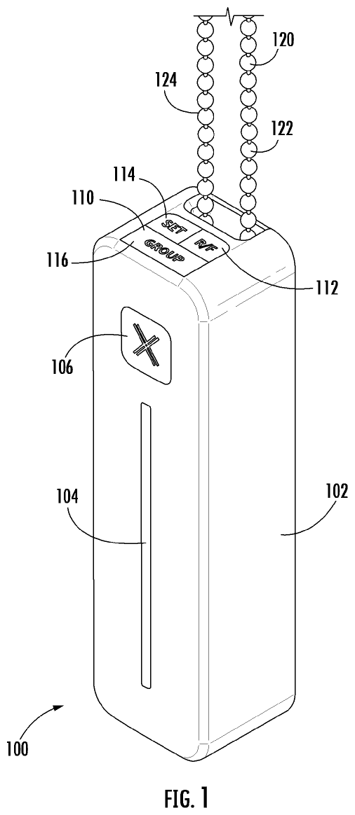

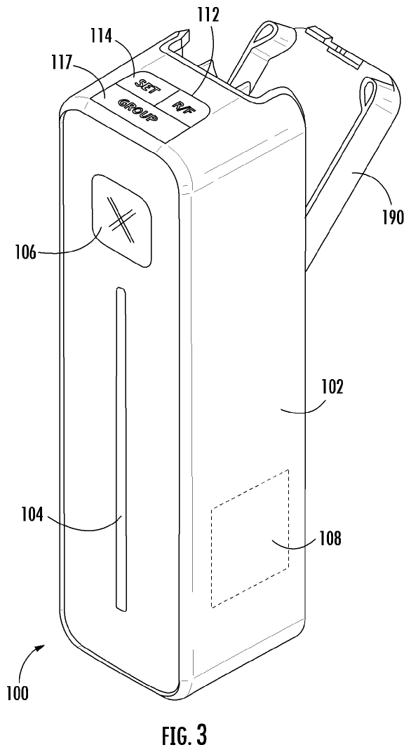

As seen in the isometric views of FIGS. 1 and 3, an external motor 100 generally corresponding to the external motor 210 of FIGS. 5 and 6 may include a housing 102 that houses a motor, associated drive mechanisms, and control electronics. External actuator 100 includes various on-device controls for user inputs and outputs. For example, external actuator 100 may include a touch strip 104 (also called slider or LED strip). In the illustrated embodiment, touch strip 104 includes a one-axis input device and a one-axis visual display. External actuator 100 further includes various button inputs including power button 106 at the front of the housing, and a set of control buttons 110 at the top of the housing. In the embodiment of FIG. 1, control buttons 110 include an RF button 112, a Set button 114, and a Group button 116. In the embodiment of FIG. 3, control buttons include an RF button 112, a Set button 114, and a PAIR button 117.

In an embodiment, buttons 106, 110 are physical (moveable) buttons. The buttons may be recessed within housing 102 or may project above the surface of housing 102. In lieu of or in addition to the touch strip and the physical buttons seen in FIG. 1, the input controls may include any suitable input mechanism capable of making an electrical contact closure in an electrical circuit, or breaking an electrical circuit, or changing the resistance or capacitance of an electrical circuit, or causing other state change of an electrical circuit or an electronic routine.

In various embodiments, alternative or additional input devices may be employed, such as various types of sensor (e.g., gesture sensor or other biometric sensor, accelerometer, light, temperature, touch, pressure, motion, proximity, presence, capacitive, and infrared (“IR”) sensors). Other user input mechanisms include touch screen buttons, holographic buttons, voice activated devices, audio triggers, relay input triggers, or electronic communications triggers, among other possibilities, including combinations of these input mechanisms.

FIG. 2 is an exploded view of the components of the external actuator 100. Starting with the components at the front of the device at lower left, a front bezel 130 includes a power button glass plate that covers the power button 106. A front lid glass plate 134 includes an aperture 132 for the power button. Front lid 136 houses the power button 106 and serves as a transparent cover plate for the touch strip 104. Visual display components of the one-axis strip 104 include LED strip (also called LEDs) 140 and a diffuser 138. The input sensor for one-axis strip 104 is a capacitive touch sensor strip 142. These components serve as an I/O device for the external motor 100, including an input interface that receives user inputs along an input axis, and a visual display aligned with the input axis. When fully assembled, the I/O device extends vertically on the exterior of the housing 102.

Other input/output components include a connector for communications and/or power transfer such as a USB port 146 and a speaker (audio output device) 144. The LEDs and audio outputs of external motor 100 can be used by state machines of external motor 100 to provide visual and/or audio cues to signal an action to be taken or to acknowledge a state change. Visual cue parameters of the LEDs 140 include, for example, (a) different positions of the LED indicators (blocks of LEDs) along slider 104; (b) different RGB color values of the LED lights; and (c) steady or flashing LED indicators (including different rates of flashing).

In examples of visual cues involving the group mode function, the user can press Group Mode button 116 once to cause external motor devices in the network to light up the LED display, informing the user which devices will be controlled. When a user successfully presses the Group Mode button 116 to program external motor 100 to control multiple external motors in its network, the LED strip 140 of all external motors being controlled will change color from steady blue to steady green.

In examples of visual cues involving the Set function, when a user initiates the calibration procedure by pressing and holding the Set button 114, the LED strip 140 will change to red and blue to inform the user that the external motor 100 is in calibration mode. When the user successfully completes the calibration procedure, the LED strip 140 will flash green to indicate that the shade is now calibrated.

In a visual cue example involving setting position, when a user taps a finger at a particular position along the capacitive touch strip 104, the LED strip 140 illuminates a block of LEDs at this position. This indicator informs the user of the position to which the shade will open or close.

In an example of audio cues, an audio alarm sounds to signal a safety issue. In a further example, the speaker 144 broadcasts directions to the user for a shade control function.

Motor drive components are housed between the main body 150 of housing 102 and a back lid 170. The motor components include motor 152 (e.g., a 6V DC motor), and various components of a drive assembly. Components of the drive assembly include a worm gear 154 that is driven by the motor rotation and coupled to a multi-stage gear assembly 160, and a clutch (not shown in FIG. 2). Gear assembly 160 includes helical gear 162 (first-stage gear), a first spur gear 164 (second-stage gear) rotatably mounted on sleeve bearings 156, and a second spur gear 166 (third-stage gear). Printed circuit board (“PCB”) 148 houses control electronics for the external motor device 100.

Spur gear 166 is coupled via a clutch (not shown) to a sprocket 184, also called driven wheel, mounted at the rear of back lid 170. Continuous cord loop (chain) 120 is threaded onto sprocket 184 so that the motion of the drive components, if coupled to the driven wheel 184 by a clutch, advances the continuous cord loop 120.

The drive assembly is configured for engaging and advancing the continuous cord loop coupled to a mechanism for raising and lowering the window covering. The drive assembly includes driven wheel 184 and a coupling mechanism (152, 160, clutch) coupling the driven wheel 184 to the output shaft of the motor. The coupling mechanism is configured for rotating the driven wheel 184 in first and second senses. Rotation of the driven wheel in a first sense advances the continuous cord loop in the first direction, and rotation of the driven wheel in a second sense advances the continuous cord loop in the second direction.

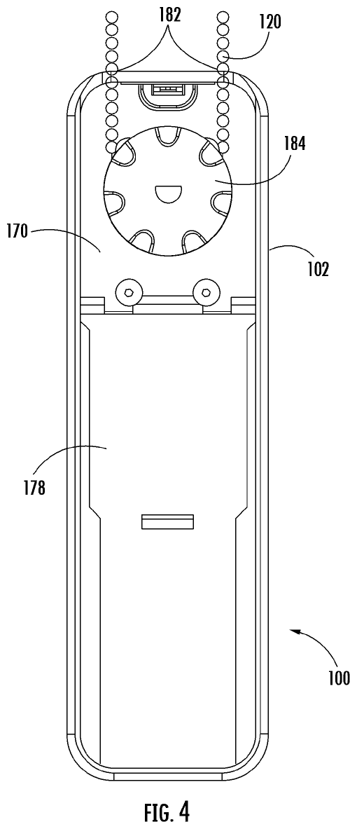

Structural components at the back of external motor 100 includes a back lid cover 178, driven wheel cover 190, back lid glass plate 180, and sprocket lid glass plate 188. These components are covered by back bezel 192, which is coupled to a bracket 194 that serves as a mounting fixture for the external motor 100. FIG. 3 is an isometric view of an external motor device with driven wheel cover 190 in an opened position. External motor 100 includes a removable panel 108 at a side of housing 102 for access to interior components of external motor 100. FIG. 4 is an elevation view of an external motor device 100 with driven wheel cover 190 removed to show a sprocket driven wheel 184. When sprocket cover 190 is closed, the housing 102 and driven wheel cover 190 define openings 182 at the top of external motor 100. The continuous cord loop 120 is routed through these openings during installation.

Referring again to FIG. 1, an input interface of external motor 100 may recognize various user input gestures in generating commands for opening or closing window coverings and other system functions. These gestures include typing-style gestures such as touching, pressing, pushing, tapping, double tapping, and two-finger tapping; gestures for tracing a pattern such as swiping, waving, and hand motion control; as well as multi-touch gestures such as pinching specific spots on the capacitive touch strip 104.

The on-device controls of the present external motors incorporate a shade positioning control I/O device such as slider 104. Slider 104 extends vertically on housing 102 along an input axis of the I/O device. The verticality of slider 104 naturally corresponds to physical attributes of shade positioning in mapping given inputs to shade control functions in a command generator, providing intuitive and user-friendly control functions. Examples of shade control I/O positioning functionality via slider 104 include, among others:
(a) A gesture at a given slider position between the bottom and top of slider 104 corresponds to a given absolute position (height) of the blind as measured by an encoder or other sensor;
(b) A gesture at a given position between the bottom and top of slider 104 corresponds to a given relative position of the blind relative to a calibrated distance between a set bottom position and a set top position (e.g., a gesture at 25% from the bottom of slider 104 corresponds to a blind position 25% of the calibrated distance from the set bottom position to the set top position);
(c) Gestures at the top and bottom of the slider 104 can execute different shade control functions depending on the gesture. Pressing and holding the top of the slider 104 is a command for the blind to move continuously upward, while pressing and holding the bottom of the slider 104 is a command for the blind to move continuously downward. Tapping the top of the slider 104 is a command for the blind to move to its top position, while tapping the bottom of the slider 104 is a command for the blind to move to its bottom position.
(d) Upward and downward dynamic gestures (e.g., swiping) on slider 104 can be assigned different functions such as “up” and “down,” or “start” and “stop.”

Slider 104 provides a versatile I/O device that is well suited to various control functions of a window coverings motor drive system. Various shade control functions may be based on a one-axis quantitative scheme associated with the touch strip 104, such as a percentage scale with 0% at the bottom of the touch strip and 100% at the top of the touch strip 104. For example, the slider 104 can be used to set blind position at various openness levels, such as openness levels 0% open (i.e., closed), 25% open, 50% open, 75% open or 100% (fully) open, via pre-set control options. A user can command these openness levels via slider 104 by swiping, tapping, or pressing various points on the slider. In addition, the slider command scheme can incorporate boundary positions for state changes. For example, a slider input below the one-quarter position of the slider can command the window covering to close from 25% open to 0% open.

Various functions of slider 104 may employ a combination of the one-axis input sensing and one-axis display features of the slider. For example, the LED strip 140 can illuminate certain positions along the touch strip 104, with these illuminated positions corresponding to boundaries along the slider for state changes in a shade command structure.

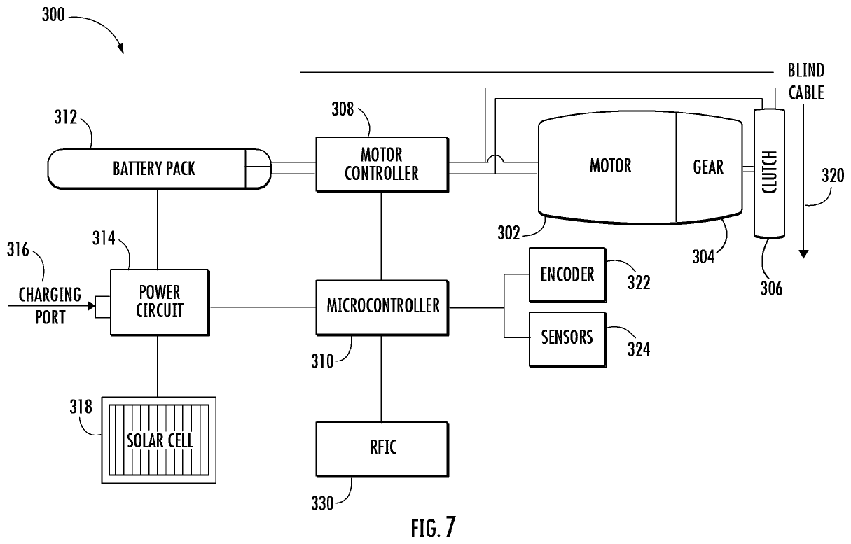

FIG. 7 is a diagram of a motor driven control system 300 for a continuous cord loop driven window covering mechanism. Control system 300 includes DC motor 302, gear assembly 304, and clutch 306. DC motor 302 and clutch 306 are both electrically powered by a motor controller 308. Power sources include battery pack 312. Users may recharge battery pack 312 via power circuit 314 using a charging port 316 or a solar cell array 318.

The central control element of control system 300 is microcontroller 310, which monitors and controls power circuit 314 and motor controller 308. In an embodiment, microcontroller 310 and motor controller 308 are battery-powered. Inputs to microcontroller 310 include motor encoder 322 and sensors 324. In an embodiment, sensors 324 include one or more temperature sensors, light sensors, and motion sensors. In an embodiment, control system 300 regulates lighting, controls room temperature, limits glare, and controls other window covering functions such as privacy.

In an embodiment, microcontroller 310 monitors current draw from the motor controller 308, and uses this data to monitor various system conditions. For example, using current draw sensing, during calibration the control system 300 can lift relatively heavy blinds at a slower speed, and relatively lighter blinds at a faster speed. In another embodiment, microprocessor 310 monitors the current draw of the motor to determine displacements from the constant current draw as an indication of position of the window covering and its level of openness. For example, assuming the blind is fully closed (0% openness), if the current draw is at an average of 1 amp while raising the window covering, the current draw may spike to 3 amps to indicate that the fabric is rolled up and the window blind is in a fully open position (100% openness).

In another embodiment, monitored current draw measurements are analyzed to determine the direction of the driven wheel, and thereby to determine the direction in which the window blind is opening or closing. In an example, the external motor drive rotates the driven wheel one way, then the opposite way, while monitoring current draw. The direction that produces the larger current draw indicates the direction in which the blind is opening. This method assumes that more torque (and greater current draw) is needed to open a window, and less torque (and lower current draw) is needed to close a window.

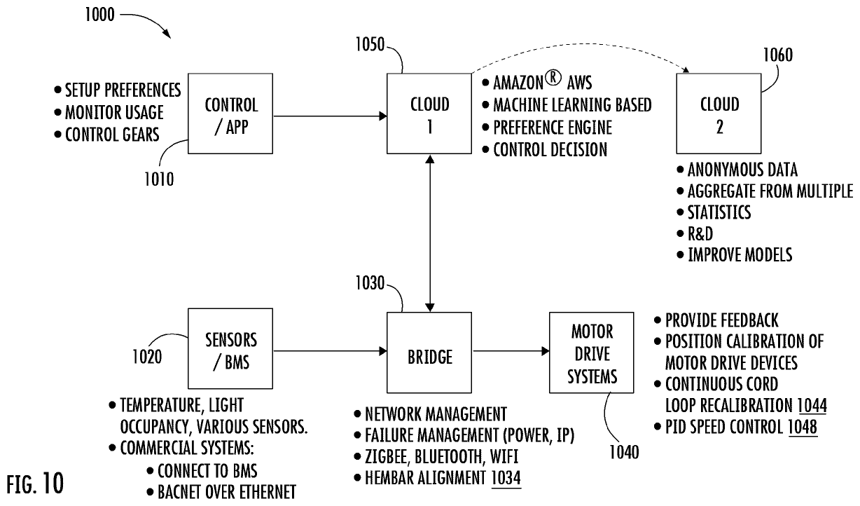

In addition, microcontroller 310 may have wireless network communication with various RF modules via radio frequency integrated circuit (“RFIC”) 330. RFIC 330 controls two-way wireless network communication by the control system 300. Wireless networks and communication devices can include a local area network (“LAN”) that may include a user remote control device, wide area network (“WAN”), wireless mesh network (“WMN”), and/or “smart home” systems and devices such as hubs and smart thermostats, among numerous other types of communication device or system. Control system 300 may employ standard wireless communication protocols such as Bluetooth, Wi-Fi, Z-Wave, ZigBee, and Thread. In an embodiment as seen in FIG. 10, a plurality of window control devices 1040 installed at a residential or commercial property transmit and receive wireless communications through a wireless bridge 1030.

An output interface 340 controls system outputs from microprocessor 310 to output devices such as LEDs 140 and speaker 144. Output interface 340 controls display of visual cues and audio cues to identify external motor control system states and to communicate messages. Input interface 350 controls system inputs from input devices such as capacitive touch device 104 and buttons 110. Input interface 350 recognizes given user inputs that can be mapped by microprocessor 310 to shade control functions in a command generator. For example, input interface may recognize given user finger gestures at a touch strip or other capacitive touch device 104.

In an embodiment, control system 300 monitors various modes of system operation and engages or disengages the clutch 306 depending on the operational state of system 300. In one embodiment, when DC motor 302 is rotating its output shaft under user (operator) control, or under automatic control by microcontroller 310, clutch 306 is engaged thereby advancing continuous cord loop 320. When microcontroller 310 is not processing an operator command or automated function to advance the continuous cord loop, clutch 306 is disengaged, and a user may advance continuous cord loop manually to operate the windows covering system. In the event of power failure, clutch 306 will be disengaged, allowing manual operation of the windows covering system.

Battery pack 312 may be an internal component of external motor device 100 contained within housing 102, or may be an external device releasably joined to housing 102. Battery pack 312 may provide a removable, rechargeable battery to power device 100.

In an embodiment, encoder 322 is a rotary encoder that outputs a given number of pulses for each revolution of the motor 302. The microcontroller 310 counts these pulses and may analyze the pulse counts to determine position and speed parameters of the window drive system 300. Various types of encoders may be used, such as magnetic encoders, mechanical encoders, etc. The number of pulses output by the encoder may be associated with a linear displacement of the blind fabric by a distance/pulse conversion factor or a pulse/distance conversion factor. In an embodiment, a position Prop of the blind cable (continuous cord loop) 320 corresponds to a fully open positon of the window blind at the top of a calibrated range of motion (0% position setting). A position P_{BOTTOM} of continuous cord loop 320 corresponds to a fully closed position of the window blind 204 at the bottom of a calibrated range of motion (100% position setting). Each of these blind positions may be associated with a respective encoder pulse count stored by the microcontroller 310. Based on the calibrated top and bottom position settings and the distance/pulse conversion factor, the external motor control system can analyze pulse count values output by encoder 322 determine the fully open position, fully closed position, and levels of openness in between. Pulses output by encoder 322 can be analyzed to calculate motor running speed. In one technique for calculating speed, as the motor increases its running speed, encoder pulses become smaller. As the motor decreases its running speed, encoder pulses become larger. Additionally, pulses output by encoder 322 can be analyzed to determine direction of motor rotation. Two encoder signals A and B are output from encoder 322. When A pulses lead B pulses, the motor is turning in one direction. When B pulses lead A pulses, the motor is turning in the opposite direction.

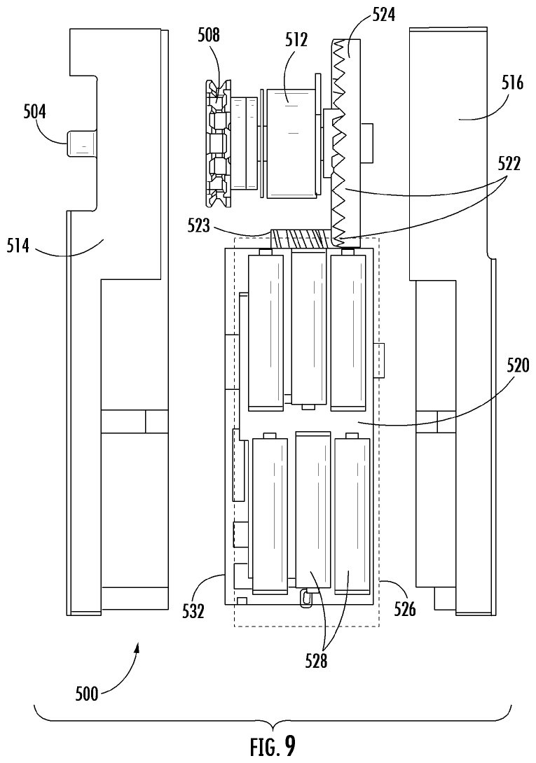

In an embodiment, the window drive system 300 may employ manual backdrive while powered when the motor is not in operation. The encoder 322 measures manual movement of the continuous cord loop due to a “tugging” or pulling action of the cord or chain by a user. With reference to FIG. 9, mechanical coupling of the driven wheel 508 to the gear assembly 522 includes a certain amount of slack, such that user's tugging on the continuous cord loop will cause a certain amount of movement of the driven wheel. This allows the user to pull or tug on the cord or chain to adjust the window covering shade while it is installed to the device. The device will detect the manual movement as a backdrive operation and measure the movement by reading the encoder pulses. The manual backdrive causes power to be transmitted to motor circuitry to actuate generation of encoder pulses. This system 300 can track the backdrive movement such that a future motor-controlled movement can continue and operate window covering movement within the calibrated range.

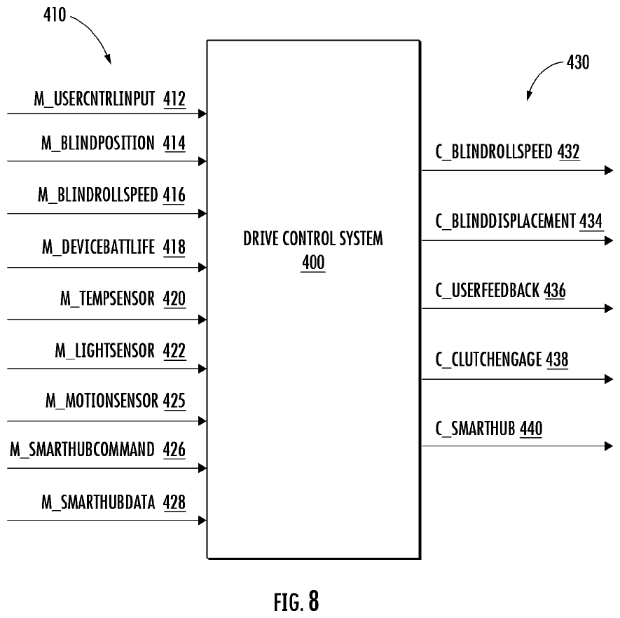

FIG. 8 is an input/output (black box) diagram of an external motor control system 400. Monitored variables (inputs) 410 of external motor control system 400 include:
a user input command for blind control (e.g., string packet containing command) 412;
distance of current position from top of blind (e.g., in meters) 414; rolling speed of the blind (e.g., in meters per second) 416;
current charge level of battery (e.g., in mV) 418; temperature sensor output (e.g., in mV) 420; light sensor output (e.g., in mV) 422; motion sensor output (e.g., in mV) 424;
smart-home hub command (e.g., string packet containing command) 426;
smart-home data (e.g., thermostat temperature value in degrees Celsius) 428; and
current draw of the motor 302 (e.g., in A) 430.

Controlled variables (outputs) 430 of external motor control system 400 include:
intended rolling speed of the blind at a given time (e.g., in meters per second) 432;
intended displacement from current position at a given time (e.g., in meters) 434;
feedback command from the device for user (e.g., string packet containing command) 436;
clutch engage/disengage command at a given time 438; and
output data to smart-home hub (e.g., temperature value in degrees Celsius corresponding to temperature sensor output 420) 440.

In an embodiment, the external motor control system 400 sends data (such as sensor outputs 420, 422, and 424) to a third-party home automation control system or device. The third-party system or device can act upon this data to control other home automation functions. Third-party home automation devices include, for example, “smart thermostats” such as the Honeywell Smart Thermostat (Honeywell International Inc., Morristown, New Jersey); Nest Learning Thermostat (Nest Labs, Palo Alto, California); Venstar programmable thermostat (Venstar, Inc., Chatsworth, California); and Lux programmable thermostat (Lux Products, Philadelphia, Pennsylvania). Other home automation devices include HVAC (heating, ventilating, and air conditioning) systems and smart ventilation systems.

In another embodiment, external motor control system 400 accepts commands, as well as data, from third-party systems and devices and acts upon these commands and data to control the windows covering system.

In an embodiment, the external motor control system 400 schedules operation of the windows covering system via user-programmed schedules.

In an embodiment, sensor outputs of motion sensor 424 are incorporated in a power saving process. Sensor 424 may be a presence/motion sensor in the form of a passive infrared (“PIR”) sensor, or may be a capacitive touch sensor, e.g., associated with a capacitive touch input interface of the external motor. In this process, the external motor system 400 hibernates/sleeps until the presence/motion sensor detects motion or the presence of a user. In an embodiment, upon sensing user presence/motion, an LED indicator of the external motor device lights up to indicate that the device can be used. In an embodiment, after a period of inactivity, the device enters a low power state to preserve energy.

In a further embodiment, external motor control system 400 controls multiple windows covering systems, and may group window covering systems to be controlled together in a group via Group Mode control. Examples of groups include external motors associated with windows facing in a certain direction and external motors associated with windows located on a given story of a building.

In another embodiment, external motor control system 400 controls the windows covering system based upon monitored sensor outputs. For example, based upon light sensor output 422, the window covering system may automatically open or close based upon specific lighting conditions such as opening blinds at sunrise. In another example, based upon motion sensor output 424, the system may automatically open blinds upon detecting a user entering a room. In a further example, based upon temperature sensor output 420, the system may automatically open blinds during daylight to warm a cold room. Additionally, the system may store temperature sensor data to send to other devices.

FIG. 9 is an elevation view of structural components and assembled working components from a motor driven subassembly 500, as seen from one side. Front housing 514 and rear housing 516 envelop the drive train and other operational components of the drive system 500, but are shown here separated from these components. DC motor 520 operates under power and control from PCB 532 and battery pack 526. Battery pack 526, shown in phantom in FIG. 9, is a battery holder with rectangular-shaped sides that can house six AAA rechargeable batteries 528, though the use of six batteries is for illustration purposes only. Batteries 528 may be nickel-metal hydride (“NiMH”) batteries or lithium-ion polymer (“LiPo”) batteries stacked within battery pack 526 in a vertical arrangement. Battery pack 526 can be located within the front housing 514 and rear housing 516 as shown or can be external to these housings. Drive system 500 may incorporate other forms of battery pack 526 and other arrangements of batteries 528 within battery pack 526. Battery pack 526 may be a removable component that can be inserted and removed at a bottom or side surface of an external motor device, such as by removing an access panel 108 at a side of external motor device 100 (FIG. 3). Batteries 528 may be recharged while battery pack 526 is housed within external motor device 100 or may be recharged after removing battery pack 526 from external motor device 100. PCB 532 may include power management components that control supply of power to motor 520, that control recharging of batteries 528, and that may include other functions such as monitoring and displaying state of charge of batteries 528.

DC motor 520 has a rotating output shaft that rotates driven wheel 508 via multi-stage gear assembly 522. Multi-stage gear assembly 522 includes a gear 523 in line with the motor output shaft and a face gear 524. Face gear 524 is coupled to driven wheel 508 by clutch system 512. Clutch 512 is a coupling mechanism that includes an engaged configuration in which rotation of the output shaft of the motor 520 (as transmitted by the multi-stage gear assembly) causes rotation of the driven wheel 508; and a disengaged configuration in which the driven wheel 508 is not rotated by the output shaft of the motor. In an embodiment, clutch 512 is an electrically operated device that transmits torque mechanically, such as an electromagnetic clutch or a solenoid. In another embodiment, clutch 512 is a two-way mechanical-only clutch that does not operate under electrical power.

In an embodiment, successive presses of the power button 504 toggle the drive assembly between engaged and disengaged configurations of the clutch system 512. Power button 504 corresponds to power button 106 in the external actuator embodiment 100 of FIG. 1. In an embodiment, power button 106 turns on or off the device by engaging and disengaging the driven wheel or sprocket 508 respectively with the clutch system 512. In another embodiment, pressing the power button 106 triggers power-on and power-off of the external actuator 100. In other embodiments, the external motor device omits a power button and the device is powered on by plugging into an external DC power source or via internal battery back.

In an embodiment utilizing a two-way mechanical-only clutch, when power button 106 is pressed in an ‘on’ position, the mechanical clutch will engage the driven wheel with the motor's output shaft and gear assembly. This is a tensioned position in which the mechanical clutch will not allow the driven wheel to be operated by manually pulling or tugging on the front chain/cord 122 or back chain/cord 124. In this engaged configuration, when the external motor 100 receives a shade control command from the on-device controls or another device, it will energize the motor to turn the output shaft and gear, which in turn will rotate the driven wheel. When the power button 106 is pressed in an ‘off’ position, the mechanical clutch will disengage the driven wheel from the output shaft and gear, allowing for manual operation of the front chain/cord 122 or back chain/cord 124. In the disengaged configuration, if a shade control command is sent when the clutch is not engaged, the driven wheel will not rotate.

In another embodiment, the clutch system is an electromagnetic clutch in which the driven wheel is always engaged with the output shaft and gear assembly. The electromagnetic clutch allows for manual operation of the front chain/cord 222 or back chain/cord 224. This clutch does not lock the driven wheel to the output shaft and gears, but when electrically energised will engage the driven wheel and output shaft and gears.

Referring again to FIG. 1, the RF button 112 is used to pair or sync the external motor to a mobile phone via RF chips including, but not limited to, BLE (“Bluetooth Low Energy”), Wi-Fi, or other RF chips. The RF button 112 can be used to pair or sync to third-party devices such smart thermostats, HVAC systems, or other smart-home devices by means of forming a mesh network utilizing RF chips including various protocols. Protocols include, but are not limited to, BLE (Bluetooth Low Energy) mesh; ZigBee (e.g., ZigBee HA 1.2); Z-Wave, Wi-Fi, and Thread.

In an embodiment, a Group button 116 adds multiple external motors 100 within a network into groups in order to control these external motors simultaneously. Group Mode allows a user to control all external motors within the group from one external motor 100. In an embodiment, to add additional external motors into a group, the user presses and holds the Group button 116 to enter pairing mode. The LED lights of touch strip 104 will flash orange to indicate the device is in pairing mode. In one embodiment, the user presses and holds, within a specified timeframe, the Group buttons of all external motors of the network they want to add into the group. The LEDs color will turn from orange to green for all external motors that have been added to the group to indicate that pairing is successful. In another embodiment, the user can press the Group button 116 once to remove a device that is currently in the group, so that the Group button executes a toggle function to add or subtract the external motor from the group. In an embodiment, the user presses the Set button 114 to complete the pairing and linking of the external motors in the group.

To control a group of external motors that are linked or synced together, the user can activate group control by pressing the Group button 116. In an embodiment, this changes the LEDs on the capacitive touch slider 104 to a different color. All external motors in this group will light or flash the same LED color to indicate that the external motor devices are in group control mode. The user can then set the position of the blind by using the capacitive touch slider control 104 to control all linked devices.

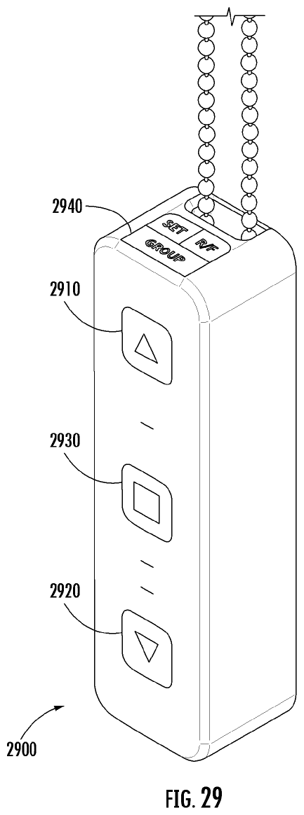

In the external motor device 2900 of FIG. 29, the vertical touch strip input device is replaced by buttons 2910, 2920, 2930 for various motion states. In an embodiment, buttons 2910, 2920, 2930 are capacitive touch buttons. In an embodiment, buttons 2910, 2920, 2930 are physical (moveable) buttons. Button 2910 actuates up motion, button 2920 actuates down motion, and stop button 2930 actuates an idle (stationary) motion state. For example, pressing an up button or down button may cause continuous up or down movement, tapping a button may cause window covering position to move up or down to a next set position, and double tapping a button may cause the window covering position to move to the top or bottom calibrated position. In a further example, in the calibration routine of FIG. 27 pressing the up button 2910 sets 2708 a calibrated top position and pressing the down button 2920 sets 2714 a calibrated bottom position. Instead of or in addition to including stop button 2930 at the front of the device, the device can include a physical stop button 2940 at the top of the device.

As an alternative to controlling Group mode via inputs at on-device buttons, in the control system embodiment 1000 of FIG. 10, Group mode may be controlled by settings at the Control/App module 1010. Group mode commands may be communicated to external motor devices 1040 within a group via wireless Bridge 1030.

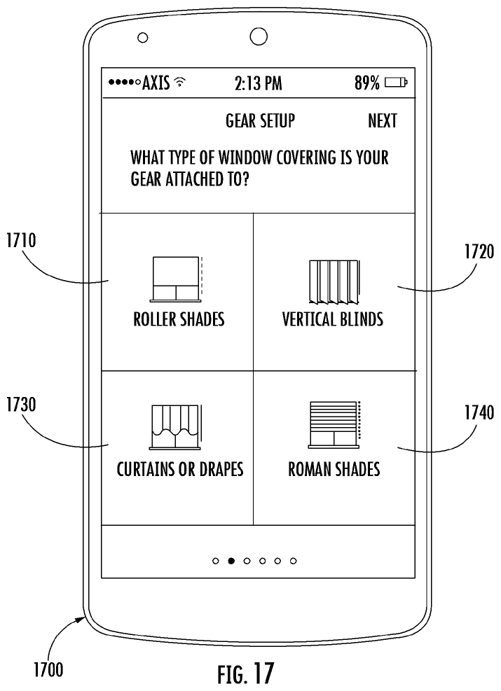

The input-output principles described above for external motor device on-device controls can be applied to various types of shade positioning control input-output (I/O) devices separate from the external motor device on-device control, such as mobile user devices. In various embodiments, the web application emulates the one-axis input sensing and one-axis display features of the external motor on-device controls described above. In various embodiments, the web application utilizes mobile device input technologies such as touch-screen inputs, gesture-based inputs, and GPS location sensing. For example, the web application control may accept inputs such as dragging, tapping, double tapping, multi-touch inputs, and gestures such as tracing a pattern, swiping, waving, and hand motion control. In various embodiments, a two-dimensional I/O device such as a 2D touch screen can be configured to act upon user input along a single axis, e.g., along a vertical axis or a horizontal axis of the touch screen. In addition to shade positioning control input-output (I/O), other graphical user interfaces of a web application control may be used for I/O functions such as setup and other control functions. FIG. 17 shows a graphical user interface 1700 displayed on an electronic device 1705 (e.g., a mobile electronic device), presenting an example setup screen of an external motor drive application. A user can select among window covering mechanisms 1710, 1720, 1730, 1740 to set up a type of window covering mechanism controlled by an external motor drive system.

FIG. 10 is a diagram of a control system 1000 that coordinates operation of a plurality of the external motor window covering drive systems, external data sources, and sensors to manage control functions. In one control function, system 1000 automates positional control of a plurality of window covering motor drive systems to synchronize raising or lowering of window covering shades with the shades in physical alignment, also herein referred to as hembar alignment 1034. In another control function, PID speed control 1048 maintains rolling speed of a window covering motor drive at a desired speed (also herein called set point or set speed). In an additional control function, continuous cord loop recalibration 1044 monitors position(s) of one or more sensor targets attached or adhered to a continuous cord loop cord. In an embodiment, upon detecting drift of one or more sensor target positions from a previously recorded position, continuous cord loop recalibration 1044 adjusts positional commands from previously set positions of the continuous cord loop, such as 0% (fully open) and 100% (fully closed). In an embodiment in which calibrated positions are based on position readings from an encoder, continuous cord loop recalibration 1044 may adjust the positional commands by calculating the drift and applying a corresponding offset to future position readings from the encoder.

In the block diagram of FIG. 10, Control/App module 1010 may represent various types of control devices. Control/App module 1010 may be designed for use with a commercial building window covering control system. In other embodiments, a simplified control system may be designed for use with a home window covering control system. In various embodiments, the control device 1010 may be implemented in a mobile device application, or desktop application. In a preferred network arrangement, the system is controlled via IP (internet protocol) communications to the “cloud.” Control/App module 1010 provides user and management level control, monitoring, setup, and override system operation. In an example, during setup a user may select whether or not to activate the hembar alignment function 1034.

In various embodiments, cloud 1050 is a back-end system that handles overall system intelligence, controls algorithms, and the decision engine. The system handles inputs from various sensors and includes deployment-specific and usage preferences. One or more automated position control APIs may make decisions on which window shades should be fully open, fully closed, or at a given intermediate level of openness. Cloud 1050 also enables third-party integration, and remote control of devices. In various embodiments, cloud 1050 incorporates machine-learning algorithms. Cloud 1050 may be a third-party cloud service.

Cloud 2 1060 is a back-end system that collects anonymous usage data and statistics used to improve algorithmic models. In various embodiments, this data is used in ongoing training and improvement of the system 1000.

Sensors/BMS module 1020 includes sensors of the external motor window covering control system such as light, temperature, and occupancy sensors of a Building Management System (BMS). In some embodiments, sensors/BMS module is integrated with building management systems, such as BACnet, which can interface with Bridge 1030 over Ethernet. BACnet is a communications protocol for Building Automation and Control (BAC) networks that leverage ASHRAE, ANSI, and ISO 16484-5 standard protocols. In various embodiments, sensors/BMS 1020 communicate with other system elements via communication protocols such as ZigBee, Bluetooth, and Wi-Fi. Outputs of the sensors/BMS module may be used in decision algorithms for one or more automated position control APIs, e.g., at Cloud module 1050.

Bridge 1030, also herein called wireless bridge or system controller, is a central conduit for wireless connectivity to the external motor window covering drive systems 1040, and to sensors, BACnet, and IP connectivity to the Cloud 1050 and to Control/App module 1010. In an exemplary commercial implementation, a Bridge device 1030 is placed on each floor of an office building according to coverage and range. In an embodiment, wireless bridge 1030 runs certain control and failure mode algorithms upon detecting loss of connectivity to Cloud 1030. Motor drive devices 1040 may provide control feedback to wireless bridge 1030. In an embodiment, wireless bridge 1030 runs hembar alignment function 1034 to automate positional control of a plurality of window covering motor drive devices 1040 by synchronizing raising or lowering of window shades. During an interval of hembar alignment, two or more of the window covering motor drive systems 1040 rise or fall together with the shades in physical alignment.

A plurality of external motor drive devices 1040 each include a respective device controller that controls positioning and motor speeds of a respective motor drive device. Motor speed of given external motor drive devices may be controlled via a PID speed control function 1048, which maintains motor speed of an external motor drive devices at a desired speed.

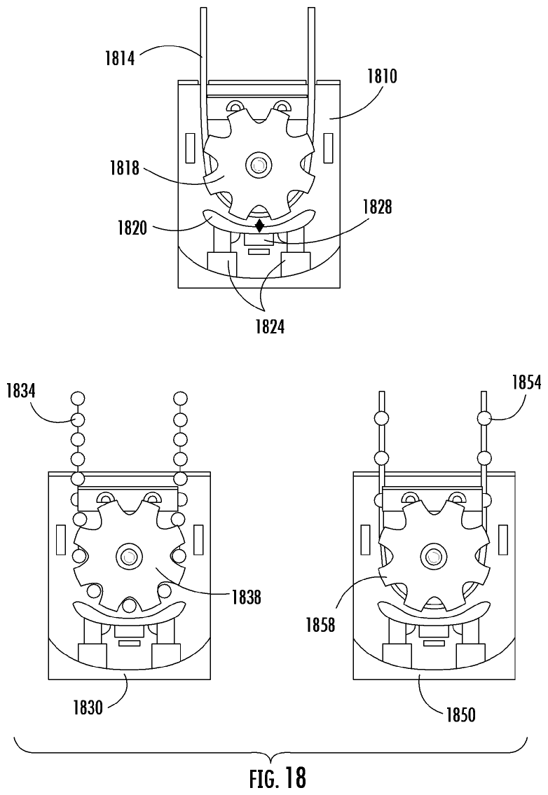

In some embodiments, positioning control of each external motor drive system 1040 is calibrated individually during setup. The calibration may set up top and bottom positions of a range of motion of the window covering mechanism as appropriate for the window covering mechanism and dimensions of the window installation. During ongoing operation following initial calibration, a continuous cord loop sensor assembly of each external motor drive system 1040 may sense position of one or more sensor targets attached to a continuous cord loop cord, such as disclosed in FIGS. 18-25. Upon detecting drift of one or more sensor target positions from a previously recorded position, continuous cord loop recalibration function 1044 adjusts the set top and bottom positions of the continuous cord loop. In an embodiment in which calibrated positions are based on position readings from an encoder, continuous cord loop recalibration 1044 may adjust the positional commands by calculating the drift and applying a corresponding offset to future position readings from the encoder

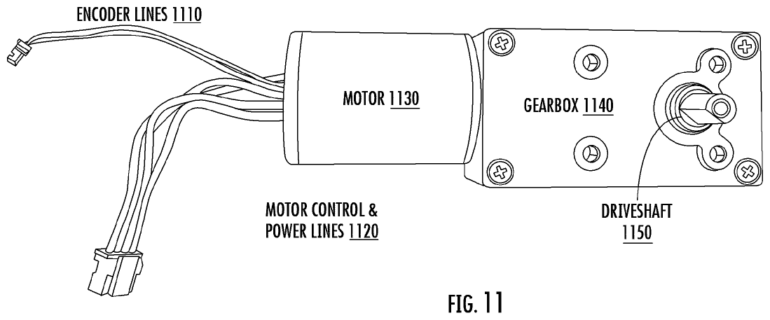

FIG. 11 shows a motor with associated encoder and drive assembly. A DC motor 1130 is attached to a gearbox 1140. The gearbox 1140 couples a rotating output shaft of the motor 1130 (not shown) to a drift shaft 1150. Drive shaft 1150 is configured to rotate a driven wheel such as a sprocket wheel or pulley to advance a continuous cord loop. The motor includes input lines 1120 that transmit power and control signals to the motor, e.g., from a motor controller. Encoder lines 1110 transmit encoder pulses generated during rotation of the output shaft of the motor, e.g., via a magnetic encoder or mechanical encoder.

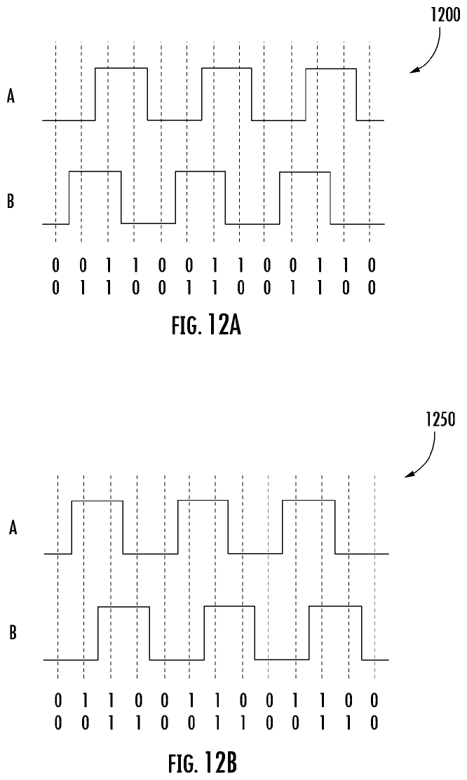

In the embodiment of FIGS. 12A and 12B, the encoder produces two signals including sets of square pulses labeled A and B. At 1200, the signal A will lead the signal B if the motor rotates in a first sense, e.g., clockwise rotation. At 1250, the signal B will lead the signal A if the motor rotates in the opposite sense, e.g., counter-clockwise rotation. This characteristic allows the controller to determine the motor's direction of rotation. In an embodiment, the encoder that outputs the sets of square pulses A, B is a quadrature encoder.

The quadrature encoder may calculate running speed of the DC motor. As the speed of rotation of motor's output shaft increases, output pulses become smaller. As the speed of rotation of motor's output shaft decreases, output pulses become larger. This relationship may be applied to calculate the motor's running speed calculation.

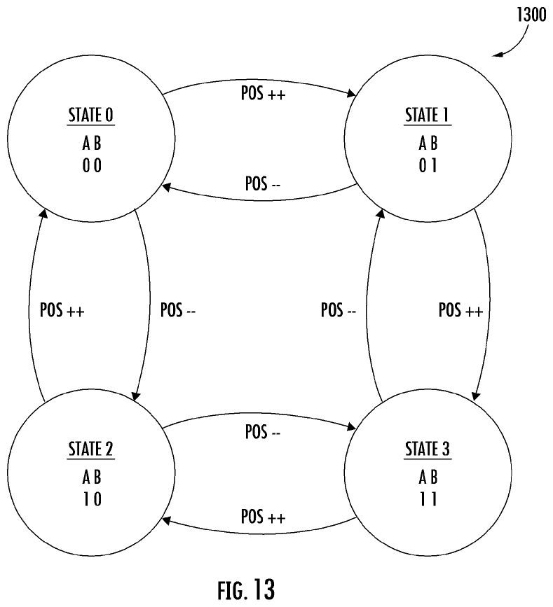

The quadrature encoder pulses are decoded in a control routine to decode the pulses into position counts. The decoded position counts may be used to determine position. The present disclosure refers to this control technique as quadrature decoder. FIG. 13 is a diagram of quadrature decoder state machine 1300. The signals A and B may be tracked based on their pulse edges to determine which signal is leading the other and thereby determine the sense of rotation.

In an embodiment, quadrature decoder state machine is used to determine the position increment or decrement steps based on the input signals including square pulses A and B. An external motor drive device controller applies the quadrature decoder state machine to the input signals to determine if the position is increasing or decreasing. In an example, the initial position is set at a known value. As the position increases or decreases from the initial value, the device controller tracks current position value.

In an example of initial calibration of positioning control, the user first moves the window covering to the fully open position and calibrates or sets the fully open position (also herein called top position, or 0% position) by recording in memory the encoder pulse count at this fully open position. The user then fully closes the window covering and calibrates or sets the fully closed position (also herein called bottom position, or 100% position) by recording in memory the encoder pulse count at this fully closed position. Once top position and bottom position are set, window covering length may be calculated as P_{BOTTOM}−P_{TOP}=Length. Subsequent commands to the external motor drive device may determine window covering positions between 0% and 100% using these saved position values. Window covering positions between 0% and 100% are also herein called levels of openness.

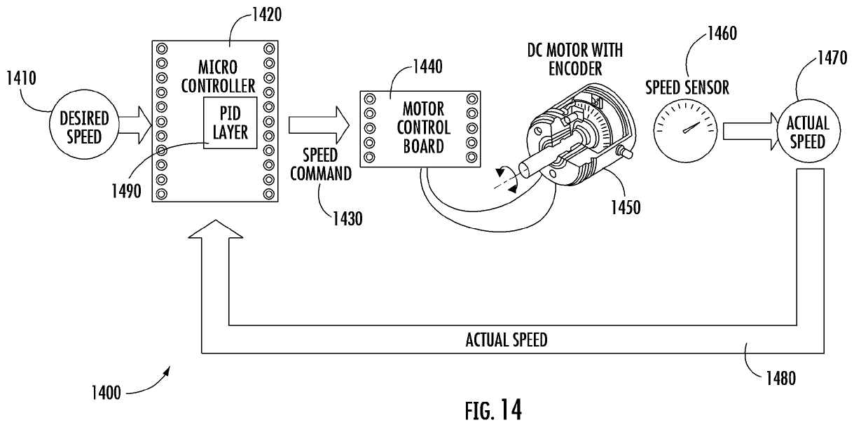

FIG. 14 is a diagram of an external motor drive system 1400 for a window covering mechanism for ensuring that actual motor speed achieves a desired speed. This drive system compensates for environmental factors that can affect speed, such as weight of shade, physical effects in continuous cord loop drive mechanisms, obstacles, and direction of motion. The system 1400 includes a microcontroller 1420 configured to transmit a speed command signal 1430 to a motor control board 1440 to control the speed of rotation of the output shaft of a DC motor with encoder 1450. In an embodiment, the DC motor with encoder is coupled to a drive assembly for advancing a continuous cord loop of a window covering mechanism. The microcontroller receives or stores a speed set-point signal representative of a desired speed 1410 of rotation of the motor, and transmits a speed command signal 1430 to the motor control board 1440. In an embodiment, the motor control board 1440 outputs power signals and control signals to DC motor with encoder 1450. The system incorporates a speed sensor 1460 for generating an actual speed of rotation signal 1470 representing a sensed speed of rotation of the motor. In an embodiment, the speed sensor 1460 receives output pulses from the encoder of the DC motor 1450 and analyzes the encoder pulses to calculate an actual speed of rotation 1470 of the motor.

The speed sensor 1460 may incorporate a control component that executes the state machine of FIG. 13. Each valid increment or decrement in position is given a timestamp value based on a time-counter running in the control component. As the motor 1450 moves it may generate many position increments/decrements in a short period of time. The control component may apply a function P_{CURRENT}−P_{PREVIOUS}/T_{DIFFERENCE} to calculate the actual speed of motor rotation 1470.

A PID speed control system of motor drive system 1400 incorporates a proportional-integral-derivative layer (PID) layer 1490 of microcontroller 1420. PID layer 1490 calculates an error value representing difference between desired set-point (desired speed 1410) and actual speed 1470 received in a closed-loop feedback signal 1480 from motor speed sensor. PID layer 1490 uses the error to generate a new output calculated as a weighted sum of control terms. These control terms may include proportional, integral, and/or derivative control terms. The calculated output automatically corrects and adjusts the drive signals to the motor 1450. On an ongoing basis, the PID speed control seeks to reduce error to 0 and thereby attain the desired speed.

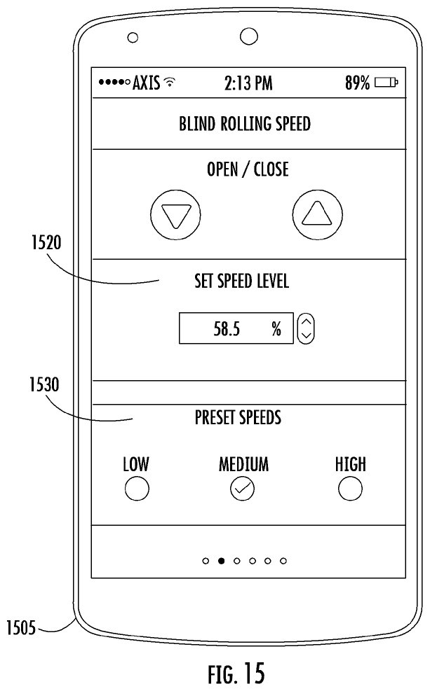

The desired speed 1410 may be a fixed speed stored by memory associated with the microcontroller, or may be a user-selected speed received by the microcontroller. In an example of fixed speed, the desired speed may be ˜80% of maximum speed of the motor, which provides tolerance for speed variations during PID speed control. In an example of user-selected speed, the speed is received from Control/App 1010 such as a mobile device 1505 as shown in FIG. 15. An illustrative speed control interface 1500 includes a control 1520 for setting an absolute value of motor speed. Additionally, the speed control interface includes controls 1530 to select one of several preset speed settings, such as a radio button control to select one of settings Low, Medium, and High.

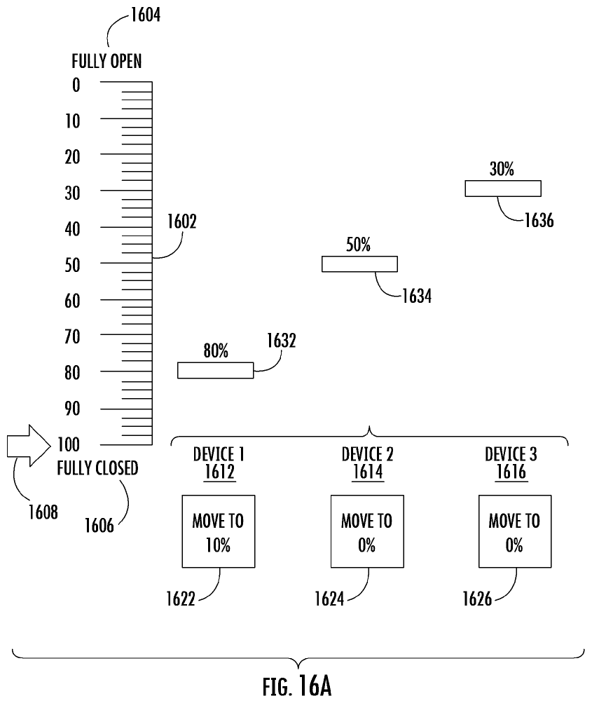

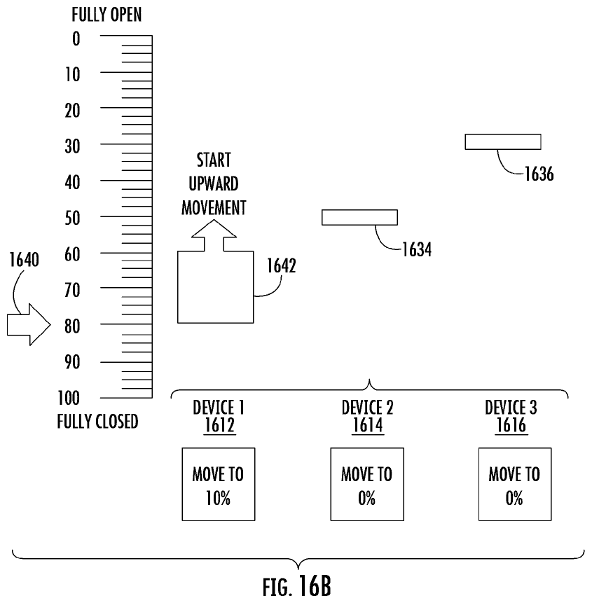

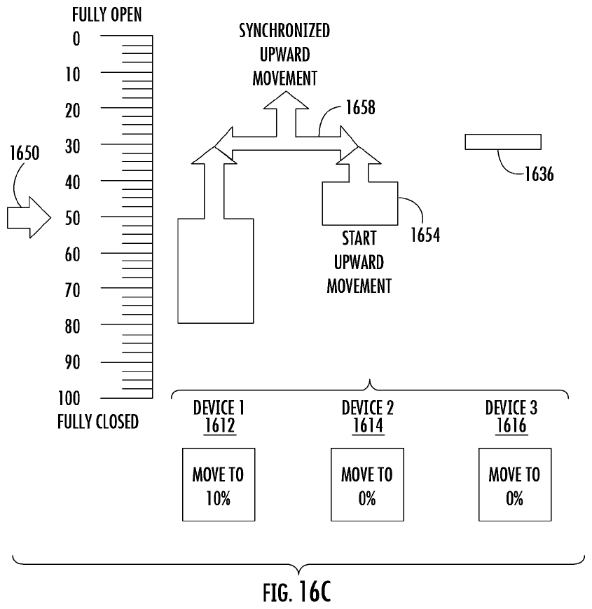

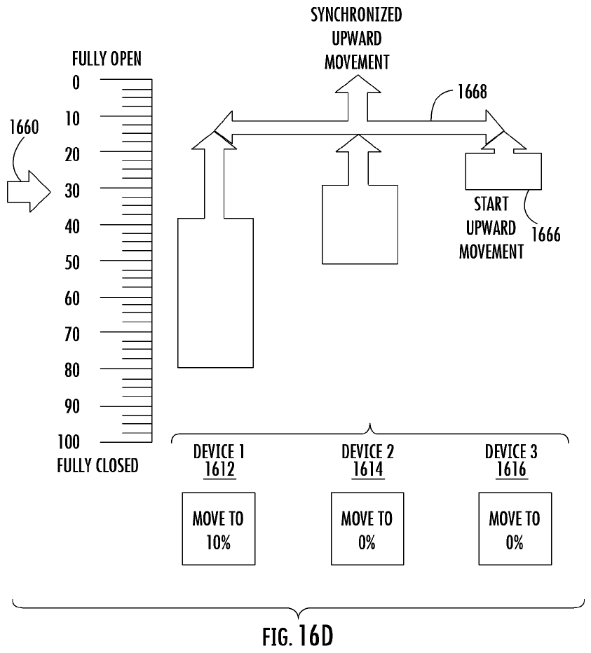

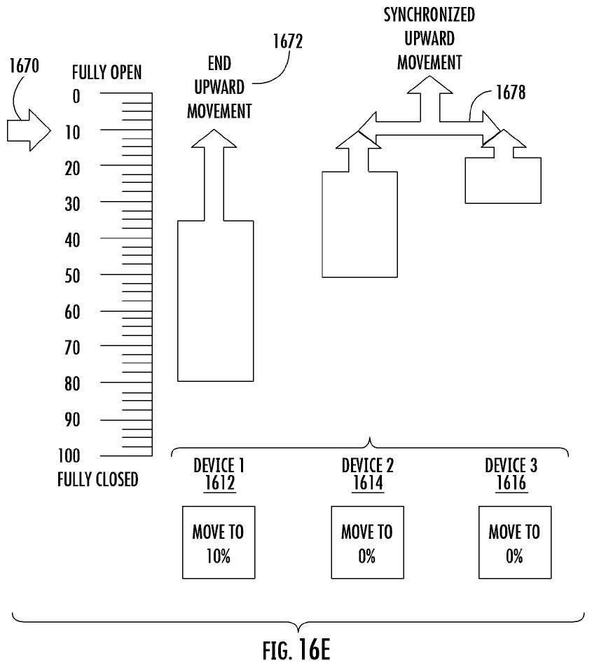

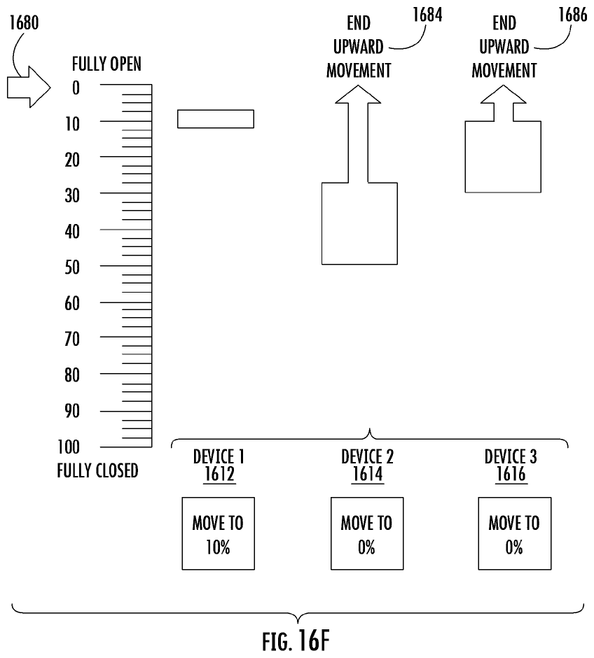

FIGS. 16A-16F provide a schematic illustration of a hembar alignment function 1034 in controlling movement of motor drive devices 1610 that include three motor drive devices 1612, 1614, 1616. The function may commence upon receiving respective positioning commands 1622, 1624, 1626. These commands instruct the system controller to advance respective continuous cord loops of devices 1612, 1614, 1616 to move the window coverings toward a fully open position 1604. In the hembar alignment function, the system controller calculates positional commands to the devices to control advancing the continuous cord loops to cause positional alignment of two or more of the window coverings, e.g., shades or blinds, over at least part of the movement. This positional alignment appears to the user as synchronized movement of the shades at the same speed, during which the lower edges (hembars) of the shades are aligned at the same level of openness.

In executing hembar alignment 1034, the bridge 1030 acting as system controller synchronizes positional commands to the motor control devices 1612, 1614, 1616 to control advancing of the respective continuous cord loops. The system controller may include a time-counter to synchronize the positional commands. As seen in FIG. 16A, a time counter 1602 is indexed to a position scale including levels of openness between 1604 (fully open) and 1606 (fully closed). For example, levels of openness may be represented by a percentage scale with values between 0% (fully open) and 100% (fully closed), inclusive. During operation of the hembar alignment function, the time-counter may iterate through time periods that index to monotonically increasing or decreasing values on the position scale (e.g., 100%, 99%, 98%, . . . 0%). This process realizes real-time control of device positioning.

In an embodiment, each of devices 1612, 1614, and 1616 includes a device controller operatively coupled to the respective motor, and the system controller comprises a bridge 1630 that transmits and receives wireless signals to and from the device controllers. The system controller may store calibrated position settings, including a first fully open position and first fully closed position of a first continuous cord loop for device 1612, a second fully open position and second fully closed position of a second continuous cord loop of device 1614, and a third fully open position and third fully closed position of a third continuous cord loop of device 1616. These position settings may be applied to calculate position values of the respective motor control device, such as motor encoder counts, corresponding to position values on the position scale (0%, 100%, and intermediate values). In an embodiment, the system controller executes a quadrature decoder state machine to determine position increment or decrement steps of the positional commands to the devices 1602, 1606, 1606 based upon motor controller output pulses received by the system controller 1030.

At an initial point in time of the hembar alignment process shown in FIG. 16A, the controller receives positional commands 1622, 1624, and 1626. Command 1622 instructs the controller to move the first device 1612 to a 10% position. Commands 1624, 1626 instruct the controller to move the second and third devices 1614, 1615 to a 0% fully open position. At this initial time the time-counter is indexed 1608 to a 100% (fully closed) position on scale 1602. Device 1 is at a starting position 1632 of 80%, device 2 is at a starting position 1634 of 50%, and device 3 is at a starting position 1636 of 30%.

At a second point in time of the hembar alignment process shown in FIG. 16B, the time-counter is indexed 1640 to an 80% position on the position scale. At this time, the first device 1612 starts upward movement 1642. At a third point in time of the hembar alignment process shown in FIG. 16C, the time-counter is indexed 1650 to a 50% position on the position scale. At this time, the second device 1614 starts upward movement 1654. This commences a time period of positional alignment during which two of the three devices, first device 1612 and second device 1614, move in synchronized upward movement 1658.

At a fourth point in time of the hembar alignment process shown in FIG. 16D, the time-counter is indexed 1660 to a 30% position on the position scale. At this time, the third device 1616 starts upward movement 1666. This commences a time period of positional alignment during which all three devices move in synchronized upward movement 1668. At a fifth point in time of the hembar alignment process shown in FIG. 16E, the time-counter is indexed 1670 to a 10% position on the position scale. At this time, the first device 1612 ends upward movement 1672. This commences a time period of positional alignment during which two of the three devices, second device 1614 and third device 1616, move in synchronized upward movement 1678. At a sixth and final point in time of the hembar alignment process shown in FIG. 16F, the time-counter is indexed 1680 to a 0% (fully open) position on the position scale. At this time, the second and third devices 1614, 1616 end upward movement 1684, 1686.

The external motor device may include various interchangeable driven wheels that are compatible with different types of continuous cord loop chains or cords. The user may attach a suitable driven wheel to a rotatable shaft of the motor drive assembly during installation or setup of the external motor device. FIG. 18 shows at 1810 a drive wheel assembly including a cord-type continuous cord loop 1814 mounted to a pulley-type driven wheel 1818. In an embodiment, the pulley wheel 1818 is compatible with cords of a given range of thicknesses and normal operation, the cord 1814 engages pulley wheel 1818 via frictional engagement. Drive wheel assembly includes a guide rail 1820 for the continuous cord loop 1814. Guide rail 1820 is a curved rail supported by support legs 1824 in proximity to or contact with a segment of the continuous cord 1814. In disclosed embodiments, drive wheel assembly 1810 includes a continuous cord loop sensor 1828 mounted to guide rail 1820. FIG. 18 shows at 1830 a metal bead continuous cord loop chain 1834 mounted to a sprocket-wheel driven wheel 1838 with cogs that mesh with the metal beads of continuous cord loop chain 1834. FIG. 18 shows at 1850 a plastic bead continuous cord loop chain 1854 mounted to a sprocket-wheel driven wheel 1858 with cogs that mesh with the plastic beads of continuous cord loop chain 1854.

In conventional practice, the primary concern is that cord/pulley motor drive systems are vulnerable to slipping during continuing operation. However, frictional engagement of the cord by the pulley drive can withstand forces applied during normal operation without slipping, and the primary cause of positioning error is material fatigue. One form of material fatigue in a synthetic or natural fiber cords is prolonged wear, which can be characterized as “creep.” Creep describes the tendency of elastic materials to move slowly or deform permanently under prolonged exposure to a continuously or continually applied mechanical load.

Conventional pulley drive systems typically focus on velocity differences during pulley drive as the most pressing concern in most practical uses of pulley drive systems. However, in motor drive systems for window coverings, another concern is relative motion between the window covering drive mechanism (e.g., continuous cord loop cord) and the pulley wheel that occurs from the difference in speed. This relative motion due to creep causes the cord to move relative to the sprocket wheel during continuing operation, which causes the final position of the window covering to move or shift over time and introduce error into position control. For example, the position control system measures relative position of the window covering by measuring encoder counts at the motor, and any movement or shift of the continuous cord loop cord relative to the pulley driven wheel can compromise accuracy of the position control system. Disclosed embodiments attempt to address the problem of creep in pulley wheel motor drive systems for cord-type continuous cord loops. Embodiments disclosed herein incorporate a continuous cord loop sensor system to address this problem.

In continuous cord loops chains driven by a sprocket wheel, stresses on the continuous cord loop chain during continuing operation can stretch or elongate the continuous cord loop chain. For example, metal beaded chains and ball chains can stretch due to stresses on the continuous cord loop chain when the motor accelerates from an idle state to full operating speed. Embodiments described herein incorporate a continuous cord loop sensor system to maintain accuracy of automated positioning control of window coverings in the event of stretching of the continuous cord loop chain.

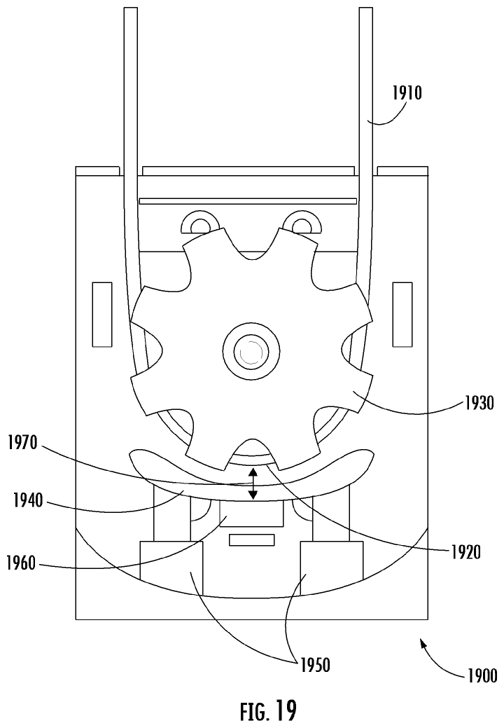

FIG. 19 shows a pulley driven wheel drive assembly 1900 including a continuous cord loop sensor system to address the problem of creep in cord-type continuous cord loop drives. The pulley driven wheel drive assembly includes a pulley type driven wheel 1930 that engages continuous cord loop cord 1910. A curved guide rail 1940, supported by support legs 1950, is located in close proximity to the cord 1910 over a segment at the lower loop end of the cord. The cord 1910 carries one or more sensor targets (also herein referred to as a target or marker) at an area of the cord's surface that faces the guide rail. A continuous cord loop sensor 1960 (also herein referred to simply as sensor) is mounted to guide rail adjacent the lowermost portion of the continuous cord loop. In this example, the sensor 1960 is a proximity sensor that is separated from the target 1920 by a short distance 1970 within the operating range of the sensor. In other embodiments, the sensor may be a contact sensor that is mounted to the guide rail in contact with the cord 1910.

A sensor target may be formed of any material suitable for marking a cord for proximity sensing or contact sensing by the sensor technology. For example, a marker may be formed of a metal, metallic alloy, other electrically conductive material, or a reflective or retroreflective material suitable for receiving an electromagnetic energy emitted by the sensor and reflecting that energy back to the sensor. The sensor target or marker can be a piece of tape, foil, coating, or printed pattern of material at a surface area of the continuous cord loop cord. The marker may have various shapes or patterns, such as rectangular, polygonal, and round, among other possibilities. The marker may be a durable material that is firmly adhered or applied to the surface of the continuous cord loop cord so as to remain intact on the cord surface during continuing operation, particularly in the case of contact sensing.

The marker, or each of multiple markers, is located at a portion of the cord that faces the sensor when the target is proximate to or in contact with the sensor during movement of the continuous cord loop cord. In one configuration, a marker is located at a single location on the cord that serves as a reference point along the length of the cord. The control system records the initial position of the reference point during system calibration. In another configuration, multiple markers are located at different initial positions, e.g., up to four positions. The controller is calibrated to store an initial position of each of the multiple markers along the continuous cord loop and is configured to receive the signal indicating presence of each sensor target and to identify a drift from the respective initial position during continuing operation of the drive system.

In an embodiment, sensor targets includes a first marker and a second marker located at two positions on the cord, e.g., a top reference point and a bottom reference point. The controller may be calibrated to store a first initial position of the first marker corresponding to a top position of the window covering and a second initial position of the second marker corresponding to a bottom position of the window covering. In an embodiment, the top and bottom reference points correspond to calibrated top and bottom limits to the range of motion of the window covering. The top reference point (initial position of the first marker) may correspond to the top position set at 2708 and the bottom reference point (initial position of the second marker) may correspond to the bottom position set at 2714 in the calibration routine of FIG. 7.

During subsequent movements of the continuous cord loop cord, when the target or one of multiple targets passes through the sensor assembly, the controller receives signals from the sensor indicating presence of the target. In an embodiment, the controller compares the target's current location with its calibration reference and generates an indication or other response in the event the controller identifies drift from the initial position. In an embodiment, the controller recalibrates the drive system to correct (adjust) window covering positioning signals for any drift detected. In the embodiment including first and second markers, the controller can recalibrate one or both of a calibrated top position and a calibrated bottom position and thereby adjust the range of motion of the window covering. In an embodiment in which calibrated positions are based on position readings from an encoder, continuous cord loop recalibration may adjust the positional commands by calculating the drift and applying a corresponding offset to future position readings from the encoder. Through this procedure, a controller of an external motor window covering drive system can compensate for creep or drift in the continuous cord loop cord, for example in the continuous cord loop recalibration function 1044 of FIG. 10.

The sensor may be a device mounted to the guiderail that is configured to output a signal indicating presence of a sensor target when a sensor target is located in proximity to or in contact with the sensor. The controller receives that signal and may generate an indication or other response to that signal. In various embodiments, the sensor is a proximity sensor, e.g., a sensor able to detect the presence of a nearby target without any physical contact and that emits an output signal when the target is located within an operating range of the sensor. In an embodiment, the proximity sensor emits an electromagnetic field or a beam of electromagnetic radiation such as infrared (IR), and looks for changes in the field or a return signal. In an embodiment, the sensor target, or each of multiple sensor targets, includes a piece of reflective material configured to reflect a beam of electromagnetic energy emitted by the sensor back to the sensor when the sensor target is located in proximity to the sensor. Proximity sensors can have a high reliability and long functional life because of the absence of mechanical parts and lack of physical contact between the sensor and the target.

In various embodiments, the sensor is a contact sensor, e.g., a sensor that senses the presence of a target via physical contact with the target and outputs a signal indicating presence of the sensor target in the event of such physical contact. In an embodiment, the contact sensor includes a plurality of contacts connected to an electrical circuit. The sensor target includes a piece of electrically conductive material that causes a short circuit in the electrical circuit when the electrically conductive material is in contact with the plurality of contacts.

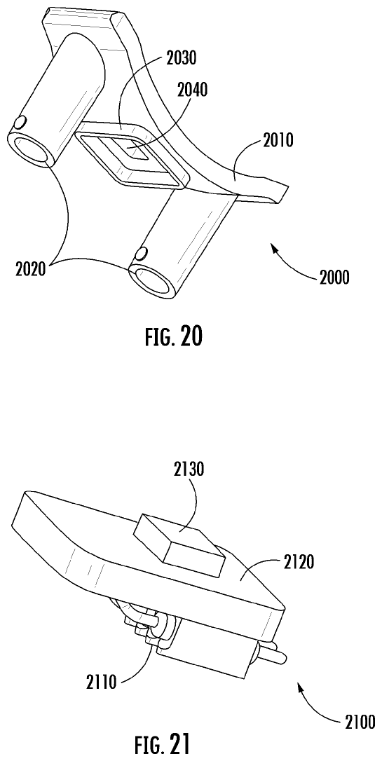

In various embodiments, an IR sensor is mounted onto or into the guide rail as a proximity sensor. The guide rail mount and IR sensor may have surface mount and through-hole mounting configurations. FIGS. 20 and 21 show a curved guide rail with mounting surface for IR sensor and an infrared sensor on PCB. In the guide rail mount 2000 of FIG. 20, a curved guide rail 2010 with support legs 2020 includes a sensor mount 2030. Sensor mount 2030 receives an IR sensor module 2100, such as the sensor 2110 on PCB 2120. Sensor 2100 has a through-hole mounting configuration in which a mounting portion 2130 is seated in an opening 2040 in the PCB.

In an example, IR sensor module 2110 includes side-by-side IR emitter and IR sensor. A 940 nm emitter (LED) is encased side-by-side facing in the same direction with a compatible silicon phototransistor. In another example, the IR sensor is a phototransistor output, reflective photointerrupter with an optimal optical sensing distance of 0.5 mm. In a further example, the IR sensor is an ultra-compact SMD type reflective microsensor with a detectable sensing distance 1.0 mm. The sensor working distance matches well with constraints imposed by mechanical layout of the external motor drive.

In an example, a target was a strip of metal tape on the cord. When the target was present within the sensor's operating range, the output of the sensor dropped to ground as it reflected off the strip of metal tape. This signal was used as hard reference point to correct for any drift in window cover positioning control. A disadvantage of IR sensors was an increased computational load on the microcomputer 310 to sample and effectively analyze the analog output signal. In testing, signal quality varied dramatically with physical configuration of the cord and marker as these characteristics affected effective distance of the target from the sensor. Signal quality may improve by perforating the metal tape before adhering the tape to the cord.

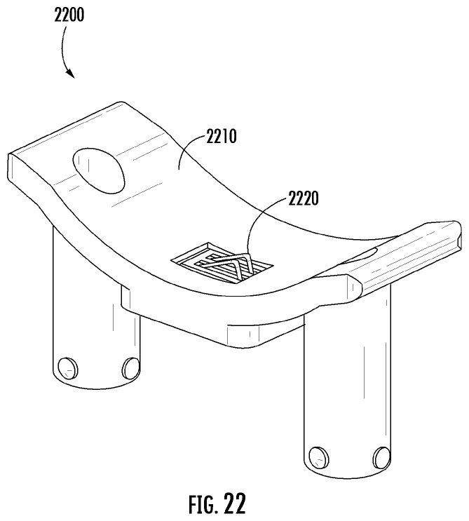

FIG. 22 shows an embodiment of continuous cord loop sensor system 2200 with a contact sensor, including a curved guide rail 2210 with leaf spring contacts 2220 that protrude above the guide rail in the absence of contact with a continuous cord loop. One objective of leaf spring sensor 2200 was to alleviate concerns of signal quality by using a well-established principle of contact sensors. The sensor 2200 has an electrical circuit including two or more contacts, in this case leaf spring contacts 2220. Physical contact of leaf spring contacts 2220 with a passing metal tape or other electrically conductive marker creates an alternative circuit path with very low electrical impedance, e.g., a short circuit. The resulting signal is a short circuit between the two leaf springs contacts, which is detectable by the microcomputer 310 providing a robust sensor that requires only modest computational load. The leaf springs' working height allowed the springs to extend into the pulley to accommodate variations in cord thickness. However, leaf spring contacts could be fragile, showing a tendency to deform during installation or use.

FIG. 23 shows an embodiment of continuous cord loop sensor system 2300 with a contact sensor, including flat contacts 2320, 2230 with electrical leads 2340, 2350 on a curved guide rail 2310. Given that the contacts have no compliance in their working height, a pulley wheel was redesigned from a traditional V-groove design. The redesigned pulley wheel had a flatter profile to allow the cord to clear the pulley's sides and touch the flat contacts consistently.

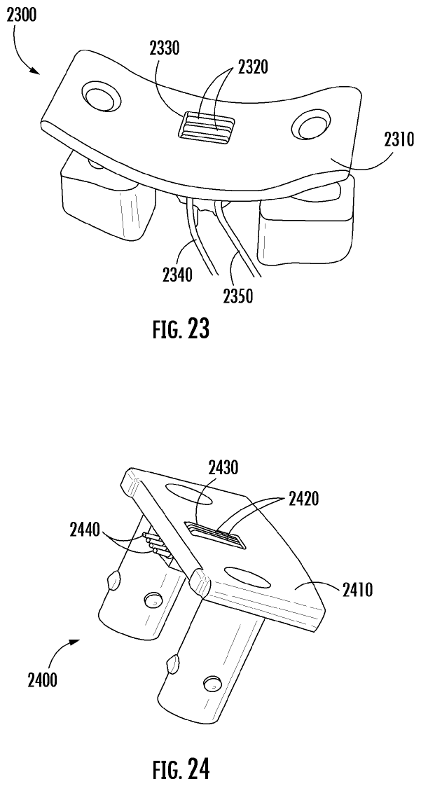

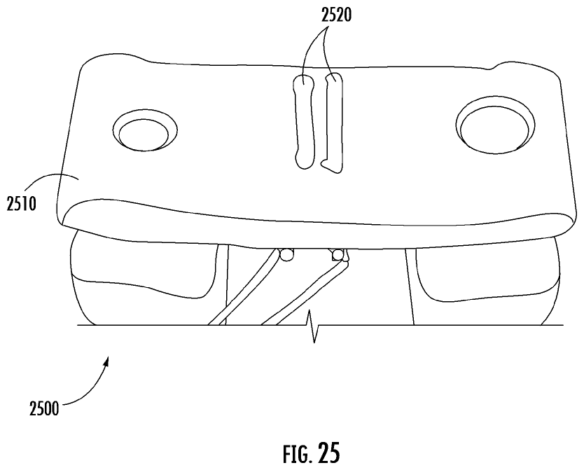

FIG. 24 shows an embodiment of continuous cord loop sensor system 2400 with a contact sensor, including flat contacts 2420 on a flat guide rail 2410. Flat contacts 2420 extend from electrical printed circuit board (PCB) 2440 through recess 2430. This design addressed a problem of the flat contacts design 2300, that bend radius of the curved guide rail 2310 could prevent the metal tape marker from achieving full contact with the flat contacts. In performance tests, the flat guide rail greatly improved reliability of a flat contacts design. Testing included two configurations for the flat contacts sensor: (a) a horizontal configuration in which the flat contacts are collinear with the continuous cord loop cord, and (b) a vertical configuration in which the flat contacts are perpendicular to the continuous cord loop cord. There are two problems with both configurations. After extended use, the closeness of connectors 2420 to the edge of recess 2430 can cause the metal tape to be caught on the contacts and pry the contacts off the PCB. If the metal tape is relatively smooth (e.g., new tape), the flat guide rail may not exert enough force in pushing the flat contacts onto the metal tape, resulting in a false negative misfire.

FIG. 25 shows an embodiment of continuous cord loop sensor system 2500 with a contact sensor, including a flat guide rail 2510 with wire contacts 2520 that protrude above the guide rail. In the design, the sensor PCB is hidden under the guide rail, thereby solving the problem in the sensor system 2400 of metal tape becoming caught on the contacts and prying the connector off the PCB. In addition, the higher profile of the wire contacts 2520 ensured that the contacts protrude into the pulley and make robust contact with the metal tape marker.

Applicants tested three configurations of the fourth contact sensor embodiment 2500: (a) 1 mm diameter wire in horizontal configuration, collinear with the continuous cord loop cord; (b) 1 mm diameter wire in vertical configuration, perpendicular to the continuous cord loop cord; and (c) 0.5 mm diameter wire in horizontal configuration, collinear with the continuous cord loop cord. In performance tests, wire contacts 2520 created a good contact with metal tape marker(s). A smooth rounded configuration of the 90° curves of wire contacts 2520 was observed to prevent the metal tape from getting caught by the contacts. The horizontal configurations performed better than the vertical configuration. One mm diameter horizontal wire contacts performed better than the 0.5 mm diameter horizontal wire contacts in that the larger diameter contacts created a stronger contact with the metal tape.

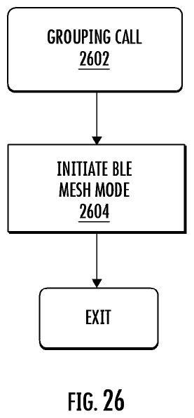

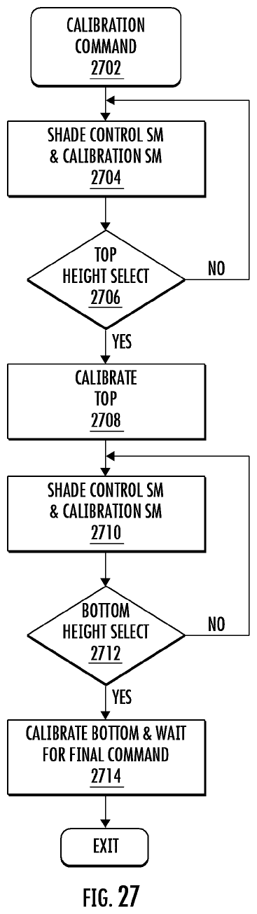

FIG. 26 is a flow chart diagram of a Grouping Mesh routine executed by an external motor in response to a grouping call received at 2602. Upon receiving the grouping call, the external motor initiates BLE mesh mode, thereby communicating messages to other external motors in the group (BLE mesh) using a BLE protocol. For external motor networks 1000 that use another protocol 1030 (FIG. 10) for wireless communications, such as ZigBee, Z-Wave, Wi-Fi, or Thread, the grouping call routine would be modified at 2604 to initiate communications with other external motors in the group based upon the applicable protocol. Similarly, the grouping call routine can be modified to adapt to different mesh topologies of the external motor network, such as hub-and-spoke (star topology).

In an embodiment, Set button 114 (FIG. 1) is used for on-device calibration of the maximum open and closed positions of the blind. After the user mounts/installs the external motor 100, the user can calibrate the device to manually set positions at which the blind is fully opened or fully closed. The user then presses the top portion of the capacitive touch slider 104 to raise the blinds all the way up. When the blind has reached the top position, the user again presses the Set button 114 to save the top position. The user then presses the bottom position of the capacitive touch slider control 104 to lower the blinds. When the blind has reached its bottom position, the user again presses the Set button to save the bottom position. The top and bottom positions set by a user can reflect preferences of the user and may vary from one external motor to another. As an alternative to on-device calibration, the maximum open and closed positions of the blind may be set up using the Control/App module 1010 (FIG. 10).

In the embodiment of FIG. 3, PAIR button 117 actuates pairing of the external motor device 100 to a mobile device 1010 or bridge 1030.

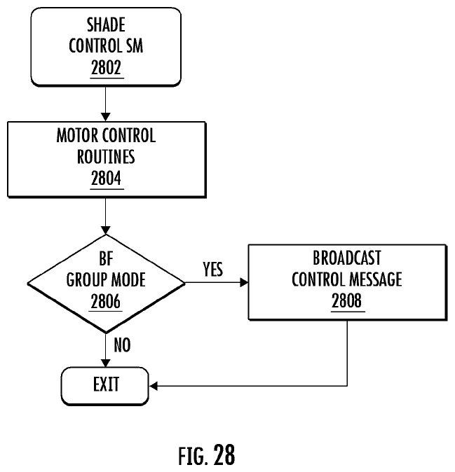

FIG. 27 is a flow chart diagram of a calibration routine for an external motor device for a window covering mechanism (e.g., device 100, device 1040). The calibration routine commences with a calibration command 2702, which can be effected by pressing and holding the Set button 114 of an external motor, or in some other way. For example, a user may provide calibration inputs using a mobile device 1010 (FIG. 10), or by pressing up and down buttons 2910, 2920 in the external motor device 2900 (FIG. 29). At 2704 the system passes control to the Shade Control state machine and to the Calibration state machine. The Shade Control state machine is discussed below with reference to FIG. 28. The Calibration state machine controls the command structure for LED indicators; calculates top and bottom positions selected by the user based on encoder pulse data; saves these top and bottom positions when confirmed by the user; and calculates distance between top and bottom positions to scale shade control commands to the calibrated positions. In these routines, the user can execute various motor control commands to move the blind to a desired top position. At 2706 the system detects whether the user has selected and confirmed the top position by pressing the Set button. If so, the routine saves (calibrates) the top position at 2708. At 2710 the system again passes control to the Shade Control state machine and to the Calibration state machine. At 2712 the system detects whether the user has selected and confirmed the bottom position by pressing the Set button and, if so, saves (calibrates) the bottom position at 2714. Upon the user's final confirmation of calibration at 2714, the system exits the calibration routine. In an embodiment, the external motor device stores calibration settings in flash memory.

In the illustrated embodiment, the calibration procedure sets the top position followed by setting the bottom position. In an alternative embodiment, instead of setting the top position followed by calibrating the bottom position, the calibration procedure sets the bottom position followed by setting the top position.

FIG. 28 is a flow chart diagram of a Shade Control routine executed by an external motor device 100. At 2802 the system receives a command to pass control to the Shade Control state machine. At 2804 the system passes control to motor control routines. Motor control routines start and stop the motor; move the motor in a selected direction (up/down); move the motor to a selected position; and regulate the speed of the motor. Motor control routines are typically triggered by user commands, but can also be automated, e.g., upon sensing a condition affecting safety. At 2806, the system detects whether Group Mode is active for the external motor. If yes, the external motor's control system broadcasts 2808 a shade control message to other motors in the group for execution. Alternatively, in the control system 1000, the wireless bridge 1030 broadcasts a shade control message to motor drives 1040 in a group for execution. Shade control commands executed in response to the message 2808 may vary among different external motors in a group. For example, shade control commands based on calibrated positions will vary depending on the top and bottom positions calibrated for each external motor drive. If the Group Mode is not active, the external motor exits the shade control routine at 2806; otherwise it exits the routine at 2808 after broadcasting the shade control message.

While various aspects and embodiments have been disclosed, other aspects and embodiments are contemplated. The various aspects and embodiments disclosed are for purposes of illustration and are not intended to be limiting, with the true scope and spirit being indicated by the following claims.

The foregoing method descriptions and the interface configuration are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code, being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (“CD”), laser disc, optical disc, digital versatile disc (“DVD”), floppy disk, and Blu-ray disc, where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

What is claimed is:

1. A motor drive system, comprising:
a first motor configured to operate under electrical power to rotate an output shaft of the first motor, wherein the first motor is external to a first mechanism for raising and lowering a first window covering;
a first drive system coupled to the output shaft of the first motor for advancing a first continuous cord loop coupled to the first mechanism for raising and lowering the first window covering, wherein advancing the first continuous cord loop in a first direction raises the first window covering, and advancing the continuous cord loop in a second direction lowers the first window covering;
a second motor configured to operate under electrical power to rotate an output shaft of the second motor, wherein the second motor is external to a second mechanism for raising and lowering a second window covering;
a second drive system coupled to the output shaft of the second motor for advancing a second continuous cord loop coupled to the second mechanism for raising and lowering the second window covering, wherein advancing the second continuous cord loop in a second direction raises the second window covering, and advancing the continuous cord loop in a second direction lowers the second window covering; and
a system controller for providing positional commands to the first motor and the second motor to control the advancing the first continuous cord loop and the second continuous cord loop,
wherein in response to receiving an instruction to advance the first continuous cord loop and the second continuous cord loop in one of the first direction or the second direction, the system controller calculates the positional commands to the first motor and the second motor to control the advancing of the first continuous cord loop and the second continuous cord loop to cause positional alignment of the first window covering and the second window covering over at least part of the advancing.

2. The motor drive system of claim 1, wherein the output shaft of the first motor and the output shaft of the second motor rotate at a common speed during the advancing in the one of the first direction or the second direction.

3. The motor drive system of claim 1, wherein the system controller is further configured to synchronize the positional commands to the first motor and the second motor to control the advancing of the first continuous cord loop and the second continuous cord loop.

4. The motor drive system of claim 1, wherein the system controller comprises a time-counter that generates clock signals to synchronize the positional commands to the first motor and the second motor to control the advancing of the first continuous cord loop and the second continuous cord loop.

5. The motor drive system of claim 1, wherein the system controller calculates the positional commands to the first motor and the second motor to cause the first window covering and the second window covering to move over a common range of level of openness over at least part of the advancing.

6. The motor drive system of claim 5, wherein in the event the first window covering is positioned at a first level of openness and the second window covering is positioned at a second level of openness when the system controller receives the instruction to advance the first continuous cord loop and the second continuous cord loop, the system controller causes the first window covering to move from the first level of openness to the second level of openness, then causes both the first window covering and the second window covering to move over the common range of level of openness.

7. The motor drive system of claim 5, wherein in the event the instruction to advance the first continuous cord loop and the second continuous cord loop comprises an instruction to advance the first continuous cord loop to a third level of openness and to advance the second continuous cord loop to a fourth level of openness, the system controller causes both the first window covering and the second window covering to move over the common range of level of openness ending at the third level of openness, then causes the second window covering to move from the third level of openness to the fourth level of openness.

8. The motor drive system of claim 1, further comprising a first device controller operatively coupled to the first motor and a second device controller operatively coupled to the second motor, wherein the system controller comprises a bridge that transmits and receives wireless signals to and from the first device controller and the second device controller.

9. The motor drive system of claim 8, further comprising a sensor target on the first continuous cord loop and a sensor for sensing position of the sensor target relative to a stored position, wherein in the event the sensor detects drift of the sensed position relative to the stored position the first device controller is configured to adjust calibrated position data comprising a first fully open position and first fully closed position of the first continuous cord loop.

10. The motor drive system of claim 9, further comprising a first encoder that generates first output pulses based upon rotation of the output shaft of the first motor, wherein in the event the sensor detects drift of the sensed position relative to the stored position the first device controller is configured to adjust the calibrated position data by applying a position offset corresponding to the detected drift to position readings of the first output pulses.

11. The motor drive system of claim 8, further comprising a first encoder that generates first output pulses based upon rotation of the output shaft of the first motor, wherein the first device controller analyzes the first output pulses to determine a first fully open position and a first fully closed position of the first continuous cord loop and to calibrate the positional commands from the system controller to the first motor.

12. The motor drive system of claim 1, further comprising
a third motor configured to operate under electrical power to rotate an output shaft of the third motor, wherein the third motor is external to a third mechanism for raising and lowering a third window covering; and
a third drive system configured for engaging and advancing a third continuous cord loop coupled to the third mechanism for raising and lowering the third window covering, wherein advancing the third continuous cord loop in a first direction raises the third window covering, and advancing the continuous cord loop in a second direction lowers the third window covering;
wherein the system controller further provides positional commands to the third motor to control the advancing the third continuous cord loop, wherein the control the advancing in the one of the first direction or the second direction causes positional alignment of at least two of the first window covering, the second window covering, and the third window covering over at least part of movement of the first window covering, the second window covering, and the third window covering.

13. A drive system for use with a window covering system including a mechanism associated with raising and lowering a window covering and a continuous cord loop extending below the mechanism for raising and lowering the window covering, the drive system comprising:
a motor configured to rotate an output shaft of the motor;
a drive assembly coupled to the output shaft of the motor and configured for engaging and advancing the continuous cord loop, wherein advancing the continuous cord loop in a first direction raises the window covering and advancing the continuous cord loop in a second direction lowers the window covering;
a controller configured to transmit a speed command signal to control the speed of rotation of the output shaft of the motor for advancing the continuous cord loop; and
a sensor for generating an actual speed of rotation signal representing a sensed speed of rotation of the output shaft of the motor,
wherein the controller comprises a proportional-integral-derivative (PID) control layer that calculates an error representing a difference between the actual speed of rotation and a speed set-point signal representing a desired speed of rotation of the output shaft of the motor, and that applies PID control terms to the error to adjust the speed command signal to the motor.

14. The drive system of claim 13, wherein the controller comprises a microcontroller including the PID control layer and a motor controller, wherein microcontroller receives the speed set-point signal and the actual speed of rotation signal representing the sensed speed of rotation and outputs the adjusted speed command signal to the motor controller.

15. The drive system of claim 14, wherein the PID control layer continuously calculates the error from the speed set-point signal and the actual speed of rotation signal received by the microcontroller.

16. The drive system of claim 13, further comprising a time-counter that generates time stamps associated with respective increment or decrement steps in rotation of the output shaft of the motor, and a sensor controller configured to calculate the sensed speed of rotation of the output shaft of the motor from difference between current position and previous position over elapsed time period.

17. The drive system of claim 13, wherein the motor comprises a DC motor, and the sensor for generating the actual speed of rotation signal comprises an encoder that generates output pulses based upon rotation of the output shaft of the DC motor.

18. The drive system of claim 17, wherein the sensor for generating the actual speed of rotation signal analyzes size of the output pulses generated by the encoder to calculate the sensed speed of rotation of the output shaft of the DC motor.

19. The drive system of claim 17, further comprising a quadrature decoder configured to determine position increment or decrement steps based upon the output pulses generated by the encoder to calculate the sensed speed of rotation of the output shaft of the DC motor.

20. The drive system of claim 17, further comprising a time-counter that generates time stamps associated with respective increment or decrement steps determined from the output pulses generated by the encoder, and a sensor controller configured to calculate the sensed speed of rotation of the output shaft of the DC motor from difference between current position and previous position over elapsed time period.
